(19) United States
(12) Patent Application Publication
(10) Pub. No.: US 2026/0172095 A1
(43) Pub. Date: Jun. 18, 2026

(54) METHOD AND AN APPARATUS FOR TRANSMITTING AND RECEIVING CHANNEL STATE INFORMATION, AND COMMUNICATION SYSTEM

(71) Applicant: 1FINITY Inc., Kawasaki-shi (JP)

(72) Inventors: Qun ZHANG, Beijing (CN); Xin WANG, Beijing (CN)

(73) Assignee: 1FINITY Inc., Kawasaki-shi (JP)

(21) Appl. No.: 19/532,716

(22) Filed: Feb. 6, 2026

Related U.S. Application Data
(63) Continuation of application No. PCT/CN2023/112409, filed on Aug. 10, 2023.

(51) Int. Cl. H04B 7/06

(52) U.S. Cl. CPC H04B 7/0626; H04B 7/0639

(57) ABSTRACT

An apparatus for transmitting channel state information, applicable to a terminal equipment, includes: first processor circuitry controlling the terminal equipment to perform the following operations: generating one or more channel state information (CSI) report(s), the CSI report comprising at least one of first CSI, second CSI or third CSI; and transmitting part or all of at least one of the CSI report to a network device according to a rule.

### CROSS-REFERENCE TO RELATED APPLICATION

This application is a continuation application under 35 U.S.C. 111(a) of International Patent Application PCT/CN2023/112409 filed on Aug. 10, 2023, and designated the U.S., the entire contents of which are incorporated herein by reference.

### TECHNICAL

Embodiments of the present disclosure relate to the field of communication technologies.

### BACKGROUND

Massive multiple-input multiple-output (MIMO) technology is one of the key technologies of 5G mobile communication. MIMO is able to offer a higher channel capacity, but attainment of these benefits depends on whether accurate channel state information can be obtained.

In the MIMO technology, a terminal equipment measures a spatial channel and feeds back channel state information (CSI) to a network device. According to channel state information reported by the terminal equipment, the network device may select an appropriate precoding matrix for the terminal equipment to perform downlink transmission, thereby reducing a received bit error probability of the terminal equipment as much as possible.

A process of generating and feeding back channel state information may be summarized as follows. A network device transmits a channel state information reference signal (CSI-RS) to each terminal equipment, and the terminal equipment estimates a channel via the received CSI-RS to obtain estimation of a spatial channel matrix. The terminal equipment further uses an estimated spatial channel to obtain CSI. In the new radio (NR) technology, a feedback mode for the CSI is implicit feedback, that is, the terminal equipment feeds back CSI in the form of recommending transmission parameters to the network device, the transmission parameters including a channel state information reference signal resource indicator (CQI), a precoding matrix indicator (PMI), a CSI-RS resource indicator (CRI), a synchronization signal block resource indicator (SSBRI), a layer indicator (LI), a rank indicator (RI), and a physical layer RSRP (L1-RSRP), etc. A base station may directly use the parameters recommended by the terminal equipment to perform downlink transmission or may not use the recommended parameters.

In a frequency division duplex (FDD) system, for downlinks, when the network device performs precoding by using information of a downlink channel, the terminal equipment needs to feed back downlink channel state information to the network device via an uplink. However, since information of a downlink channel is proportional to the number of antennas of the network device, in a scenario of massive MIMO, the huge number of antennas of the network device will lead to an extremely huge channel state information feedback amount of the downlink channel. The 3rd Generation Partnership Project (3GPP) designs enhanced codebooks for downlink feedback (such as etype II codebook). A feedback amount of channel state information is reduced via frequency-domain compression, but for precious uplink resources, there is still a demand to further reduce an uplink feedback amount.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

With the development of Artificial Intelligence/Machine Learning (AI/ML) technology, it has become a current technical direction to apply the Artificial Intelligence/Machine Learning technology to a physical layer of wireless communication, so as to solve the difficulties of traditional methods.

FIG. 1 is a schematic diagram of performing CSI feedback based on AI/ML. An AI/ML module may include an AI/ML-based CSI generation part and an AI/ML-based CSI reconstruction part. The AI/ML-based CSI generation part includes an AI/ML model, the AI/ML model may include an AI/ML encoder and a quantizer, in addition, the AI/ML model may further include a preprocessing module. The AI/ML-based CSI reconstruction part includes an AI/ML reconstruction model, the AI/ML reconstruction model includes a dequantizer and an AI/ML decoder, in addition, the AI/ML reconfiguration model may further include a post-processing module.

As shown in FIG. 1, in operation 101, a terminal equipment side perform processing by using the AI/ML-based CSI generation part to obtain CSI; a network device receives the CSI via an air interface; and in operation 102, the network device processes the received CSI by using the AI/ML-based CSI reconstruction part to obtain recovered CSI.

In a case where uplink resources are limited, the terminal equipment needs to select to transmit at least a part of a CSI report, while not transmitting remaining parts.

Inventor of the present disclosure finds that how to determine transmitting at least a part of the CSI report is a problem that needs to be solved.

For at least one of the above problems or other similar problems, the embodiments of the present disclosure provide a method and an apparatus for transmitting and receiving channel state information, and a communication system. In this method, a terminal equipment transmits part or all of at least one CSI report to a network device according to a rule.

According to an aspect of the embodiments of the present disclosure, an apparatus for transmitting channel state information is provided, applicable to a terminal equipment, the apparatus including a first processing unit, the first processing unit controlling the terminal equipment to perform the following operations:
the terminal equipment generates at least one channel state information (CSI) report, the CSI report including at least one of first CSI, second CSI or third CSI; and
the terminal equipment transmits part or all of at least one of the CSI reports to a network device according to a rule.

According to another aspect of the embodiments of the present disclosure, an apparatus for receiving channel state information is provided, applicable to a network device, the apparatus including a second processing unit, the second processing unit controlling the network device to perform the following operation:
the network device receives part or all of at least one channel state information (CSI) report transmitted by a terminal equipment based on a rule, the CSI report including at least one of first CSI, second CSI or third CSI.

One of advantageous effects of the embodiments of the present disclosure lies in that in the method, a terminal equipment transmits part or all of at least one CSI report to a network device according to a rule, whereby in a case where resources of an uplink channel (a PUCCH and/or a PUSCH) are limited, the terminal equipment may discard CSI according to the rule, which not only makes reasonable use of the resources of the uplink channel, but also avoids ambiguity that may occur when the network device reads the CSI.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF THE DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in at least one implementation.

FIG. 1 is a schematic diagram of performing CSI feedback based on AI/ML;

FIG. 2 is a schematic diagram of a communication system of the present disclosure;

FIG. 3 is a schematic diagram of a method for transmitting channel state information (CSI) in the embodiments of a first aspect of the present disclosure;

FIG. 4 is a schematic diagram of a method for receiving channel state information (CSI) in the embodiments of a second aspect of the present disclosure;

FIG. 5 is a schematic diagram of an apparatus for transmitting channel state information (CSI) in the embodiments of a third aspect of the present disclosure;

FIG. 6 is a schematic diagram of an apparatus for receiving channel state information (CSI) in the embodiments of a fourth aspect of the present disclosure;

FIG. 7 is a schematic diagram of a terminal equipment in the embodiments of a fifth aspect; and

FIG. 8 is a schematic diagram of a network device in the embodiments of a fifth aspect.

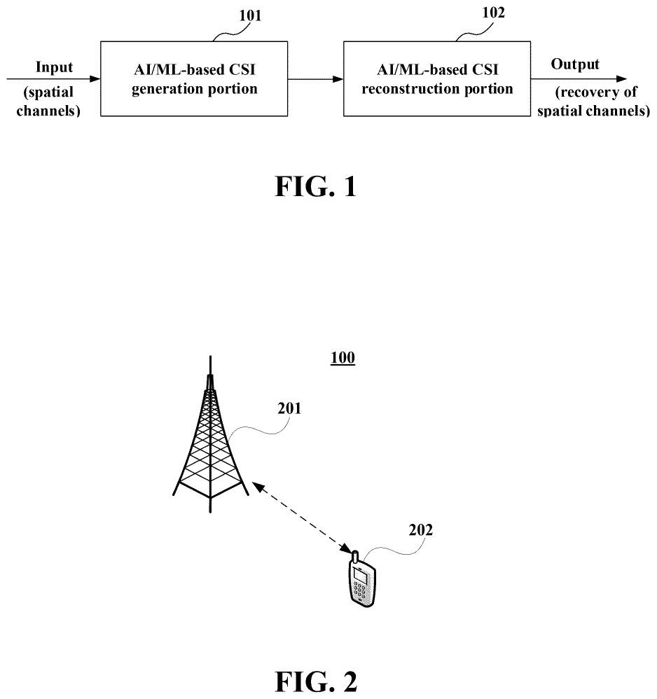

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as New Radio (NR), Long Term Evolution (LTE), LTE-Advanced (LTE-A), Wideband Code Division Multiple Access (WCDMA), and High-Speed Packet Access (HSPA).

And, communication between devices in a communication system can be carried out according to a communication protocol at any stage, for example may include but be not limited to the following communication protocols: 1G (generation), 2G, 2.5G, 2.75G, 3G, 4G, 4.5G, 5G, and New Radio (NR), and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: an Integrated Access and Backhaul node (IAB-node), a Base Station (BS), an Access Point (AP), a Transmission Reception Point (TRP), a broadcast transmitter, a Mobile Management Entity (MME), a gateway, a server, a Radio Network Controller (RNC), and a Base Station Controller (BSC).

The base station may include but be not limited to: node B (NodeB or NB), evolution node B (eNodeB or eNB) and a 5G base station (gNB), and may further includes Remote Radio Head (RRH), Remote Radio Unit (RRU), a relay or a low power node (such as femto, and pico). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, and a digital camera.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, and a Machine to Machine (M2M) terminal.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipments as described above.

In the following description, without causing confusion, the terms “uplink control signal” and “Uplink Control Information (UCI)” or “Physical Uplink Control Channel (PUCCH)” are interchangeable, and the terms “uplink data signal” and “uplink data information” or “Physical Uplink Shared Channel (PUSCH)” are interchangeable.

The terms “downlink control signal” and “Downlink Control Information (DCI)” or “Physical Downlink Control Channel (PDCCH)” are interchangeable, and the terms “downlink data signal” and “downlink data information” or “Physical Downlink Shared Channel (PDSCH)” are interchangeable.

Moreover, transmitting or receiving a PUSCH can be understood as transmitting or receiving uplink data carried by the PUSCH, transmitting or receiving a PUCCH can be understood as transmitting or receiving uplink information carried by the PUCCH, transmitting or receiving a PRACH can be understood as transmitting or receiving a preamble carried by the PRACH; an uplink signal may include an uplink data signal and/or an uplink control signal, etc., or may also be referred to as UL transmission or uplink information or uplink channel. Transmitting an uplink transmission on an uplink resource can be understood as transmitting the uplink transmission by using the uplink resource. Similarly, downlink data/signals/channels/information may be understood accordingly.

In the embodiments of the present disclosure, higher layer signaling may be e.g. radio resource control (RRC) signaling; for example, is called an RRC message, for example includes an MIB, system information, and a dedicated RRC message; or is called an RRC information element (RRC IE). The higher layer signaling, for example, may further be Medium Access Control (MAC) signaling; or called a MAC control element (MAC CE). However, the present disclosure is not limited thereto.

Scenarios of the embodiments of the present disclosure are described through the following examples, however the present disclosure is not limited thereto.

FIG. 2 is a schematic diagram of a communication system in the present disclosure, schematically describes situations by taking a terminal equipment and a network device as examples, as shown in FIG. 2, a communication system 100 may include a network device 201 and a terminal equipment 202 (for the sake of simplicity, FIG. 2 makes the description only by taking one terminal equipment as an example).

In the embodiments of the present disclosure, existing or further implementable services can be carried out between the network device 201 and the terminal equipment 202. For example, these services include but are not limited to: enhanced Mobile Broadband (eMBB), massive Machine Type Communication (mMTC), and Ultra-Reliable and Low-Latency Communication (URLLC).

The terminal equipment 202 may transmit data to the network device 201, for example, using an authorized or unauthorized transmission mode. The network device 201 may receive the data transmitted by one or more terminal equipments 202, and feedback information to the terminal equipment(s) 202, such as acknowledgment ACK/non-acknowledgment ACK information, the terminal equipment(s) 202 may confirm ending a transmission process, or may further perform new data transmission, or may perform data retransmission, according to the feedback information.

In the following description of the present disclosure, an artificial intelligence (AI) model may further be referred to as an artificial intelligence/machine learning (AI/ML) model, these two nouns may be interchangeable.

In each of the embodiments of the present disclosure, signaling transmitted by a network device to a terminal equipment may be transmitted via downlink control information (DCI), and/or a media access control control element (MAC CE), and/or radio resource control (RRC) signaling.

In each of the following embodiments of the present disclosure, an AI/ML-based CSI generation part and an AI/ML-based CSI reconstruction part have a pairing relationship. The former may be applicable to a terminal equipment side, and the latter may be applicable to a network device side. If a terminal equipment uses a certain AI/ML-based CSI generation part, a network device is required to use an AI/ML-based CSI reconstruction part paired with the AI/ML-based CSI generation part to successfully reconstruct channel information. If the network device uses a certain AI/ML-based CSI reconstruction part, the terminal equipment is required to use an AI/ML-based CSI generation part paired with the AI/ML-based CSI reconstruction part to successfully reconstruct channel information at the network device side.

The AI/ML-based CSI generation part includes an AI/ML model, the AI/ML model may be used to generate at least one of precoding matrix information, a rank indicator (RI), a layer indicator (LI), a channel resource indicator (CRI), or a channel quality indicator (CQI). Moreover, RI, LI, CRI and CQI may further not be generated by the AI/ML model. For example, the AI/ML-based CSI generation part may further include at least one of a module for generating an RI, a module for generating an LI, a module for generating a CRI or a module for generating a CQI. The AI/ML-based CSI generation part may further include other modules, such as a module for truncating a bit sequence.

Information of the AI/ML-based CSI generation part may consist of AI/ML model information and/or information of the module for generating an RI and/or information of the module for generating an LI and/or information of the module for generating a CRI and/or information of the module for generating a CQI and/or information of the module for truncating a bit sequence and/or information of other functional modules (if any).

The AI/ML model may include three parts, i.e., a preprocessing module, an AI/ML encoder, and a quantizer; accordingly, the AI/ML model information may include preprocessing module information, AI/ML encoder information, and quantizer information. For example, one piece of the AI/ML model information may be described by using “preprocessing module #2, AI/ML encoder #4, quantizer #A”. In addition, the preprocessing module, the AI/ML encoder and the quantizer may further be regarded as a whole to label the AI/ML model information. That is, the AI/ML model information may further be expressed as, for example, AI/ML model information #4.

An AI/ML reconstruction model of the AI/ML-based CSI reconstruction part paired with an AI/ML model in the AI/ML-based CSI generation part may also include three parts, i.e., a dequantizer, an AI/ML decoder and a post-processing module; accordingly, the AI/ML reconstruction model information may include dequantizer information, AI/ML decoder information and post-processing module information. For example, one piece of the AI/ML reconstruction model information may be described by using “dequantizer #B, AI/ML decoder #1, post-processing module #2”. In addition, the AI/ML reconfiguration model information may further be represented as, for example, AI/ML reconfiguration model #1, or simply called AI/ML model #1, to indicate a pairing relationship with AI/ML model #1 in the AI/ML-based CSI generation part.

The AI/ML model may also consist of two parts (for example, without a preprocessing module, or the preprocessing module is included in the AI/ML encoder and is regarded as a whole with the AI/ML encoder), that is, the AI/ML model includes an AI/ML encoder and a quantizer. At this point, the AI/ML model information may consist of AI/ML encoder information and quantizer information. The AI/ML reconstruction model of the AI/ML-based CSI reconstruction part paired with the AI/ML model may also consist of two parts, i.e., a dequantizer and an AI/ML decoder. At this point, the AI/ML reconstruction model information consists of dequantizer information and AI/ML decoder information. The preprocessing module may be included in the AI/ML encoder or may not be included in the AI/ML encoder. The post-processing module may be included in the AI/ML decoder or may not be included in the AI/ML decoder.

The AI/ML model may further consist of one part, that is, the AI/ML encoder and the quantizer are regarded as a whole (for example, the AI/ML encoder and the quantizer are inseparable and not freely combinable), and the AI/ML encoder may or may not include a preprocessing module. At this point, the AI/ML model information only consists of one part. For example, the AI/ML model information is AI/ML model #5. The AI/ML reconstruction model may further consist of one part, that is, the dequantizer and the AI/ML decoder are regarded as a whole (for example, the AI/ML decoder and the dequantizer are inseparable and not freely combinable), and the AI/ML decoder may or may not include a post-processing module. At this point, the AI/ML reconfiguration model information only consists of one part. For example, the AI/ML reconfiguration model information is AI/ML reconfiguration model #5, or simply called AI/ML model #5, to indicate a pairing relationship with AI/ML model #5 in the AI/ML-based CSI generation part.

In each embodiment of the present disclosure, for more than two CSI reports, there are the following prerequisites:
the more than two CSI reports have the same time-domain characteristics (for example, they are both aperiodic, semi-persistent or periodic in a time domain);
the more than two CSI reports are transmitted on channels of the same type, the channel, for example, is a physical uplink shared channel (PUSCH) or a physical uplink control channel (PUCCH);
each CSI report simultaneously includes a layer indicator reference signal received power (LI-RSRP) and/or a layer indicator Signal-to-Interference-plus-Noise Ratio (LI-SINR), or each CSI report simultaneously does not include the L1-RSRP or L1-SINR;
the more than two CSI reports have the same serving cell index; and
channel state information report configuration identifiers (CSI-reportConfigID) corresponding to the more than two CSI reports may be the same or different.

In each embodiment of the present disclosure, reporting may refer to an action in which a terminal equipment transmits information to a network device. For example, the terminal equipment reports a CSI report, which may refer to that the terminal equipment transmits the CSI report to the network device.

### Embodiments of a First Aspect

Embodiments of a first aspect provide a method for transmitting channel state information, the method is applicable to a terminal equipment.

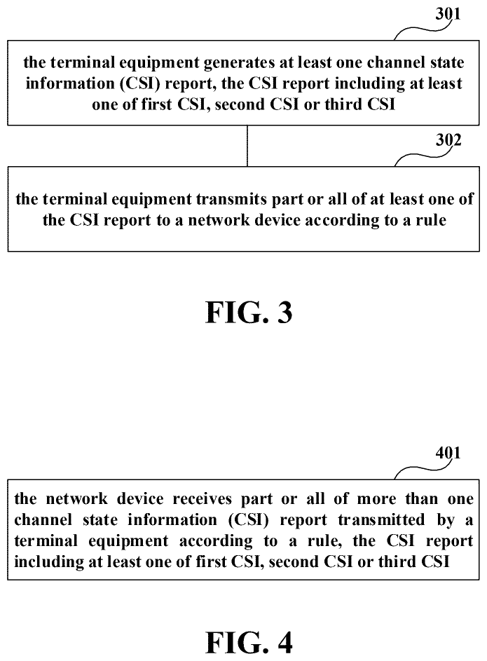

FIG. 3 is a schematic diagram of a method for transmitting channel state information in the embodiments of a first aspect. As shown in FIG. 3, the method includes:
operation 301, the terminal equipment generates at least one channel state information (CSI) report, the CSI report including at least one of first CSI, second CSI or third CSI; and
operation 302, the terminal equipment transmits part or all of at least one of the CSI report to a network device according to a rule.

According to the embodiments of the first aspect, a terminal equipment transmits part or all of at least one CSI report to a network device according to a rule, whereby in a case where resources of an uplink channel (a PUCCH and/or a PUSCH) are limited, the terminal equipment may discard CSI according to the rule, which not only makes reasonable use of the resources of the uplink channel, but also avoids ambiguity that may occur when the network device reads the CSI.

In at least one embodiment of operation 301, the CSI report further includes fourth CSI.

In at least one embodiment, the CSI report is associated with at least one CSI-RS resource. For example, CSI (at least one of first CSI, second CSI, third CSI or fourth CSI) included in the CSI report is associated with at least one CSI-RS resource.

In at least one embodiment, precoding matrix information of the first CSI is generated by an AI/ML (artificial intelligence) model; and/or
at least a part of the second CSI is second information, the second information being obtained by performing scalar quantization on a right singular vector of a spatial channel matrix and/or a eigenvector of the spatial channel matrix and/or one or more elements of the spatial channel matrix; and/or
at least a part of the fourth CSI is precoding matrix information obtained using a first codebook, for the right singular vector of the spatial channel matrix and/or the eigenvector of the spatial channel matrix; and/or
at least a part of the third CSI is third information, the third information being precoding matrix information obtained by using a codebook obtained by expanding a value range of at least one parameter of the first codebook, for the right singular vector of the spatial channel matrix and/or the eigenvector of the spatial channel matrix.

The first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook. In at least one embodiment of operation 302, the rule may be configured by a network device; or, the rule may be determined by a terminal equipment, and the terminal equipment may transmit the determined rule to the network device; or, the rule is predefined.

For example, the terminal equipment receives information for indicating an available rule for the terminal equipment, the information is configured by the network device. In the example:
when number of the available rule indicated by the information is one, the rule is the one available rule; or, when the number of the available rules indicated by the information is at least two, the rule is determined by the terminal equipment from the at least two available rules.

In at least one embodiment, the terminal equipment is configured with the information of the rule by the network device, the information including an index and/or a number and/or a bitmap of the rule; and/or, the terminal equipment transmits information of the determined rule, the information including an index and/or a number and/or a bitmap of the rule.

In at least one embodiment of operation 302, the rule includes at least one of a first rule, a second rule, a third rule or a fourth rule. In the embodiment:
the first rule is an order corresponding to CSI types, the CSI types, for example, being the aforementioned first CSI, second CSI, third CSI or fourth CSI; and/or
the second rule is an order of the CSI reports, such as an order among different CSI reports when the number of CSI reports is at least two; and/or
the third rule is an order of the second information in the CSI reports, such as an order among different pieces of second information when the number of pieces of second information in one CSI report is at least two; and/or
the fourth rule is an order of the third information in the CSI reports, such as an order among different pieces of third information when the number of pieces of third information in one CSI report is at least two.

In at least one embodiment, the order may be at least one of a priority order, a report order or a priority level.

In the following text, the embodiments of the first aspect of the present disclosure are further described in combination with different embodiments. In each of the following embodiments, description is made by taking the order being a priority order as an example, which is also applicable to situations in which the order is a report order and/or a priority level.

### Embodiment 1

Embodiment 1 illustrates the third rule (such as a priority order of the second information). In one piece of the second CSI of one CSI report, the third rule is associated with frequency domain information and/or spatial domain information.

The frequency domain information includes information of subbands and/or information of subcarriers and/or information of bandwidths; the spatial domain information includes information of spatial domain layers and/or information of antenna ports.

The information of subbands and/or information of subcarriers and/or information of bandwidths and/or the information of spatial domain layers and/or information of antenna ports include(s) at least one of an index, a bitmap or an identifier.

For example, the third rule is a mapping of an order of the frequency domain information, and for the same frequency domain information, the third rule is a mapping of an order of the spatial domain information; or, the third rule is a mapping of an order of the spatial domain information, and for the same spatial domain information, the third rule is a mapping of an order of the frequency domain information.

In some implementations, for two or more CSI reports, the rule further includes that: the second rule takes precedence over the third rule, or, the third rule takes precedence over the second rule; or, the second rule and the third rule are independent of each other.

The following text describes situations in which the third rule in Embodiment 1 is associated with frequency domain information.

In some implementations, at least a part of the second CSI is second information. The second CSI may further include a rank indicator (RI) or may not include the RI. For the former (i.e., including the RI), the second CSI may be divided into at least two parts. A first part of CSI (Part 1 CSI) includes the RI, and a second part of CSI (Part 2 CSI) includes at least a part of the second information. For the latter (i.e., not including the RI), the second CSI may only have one part (the whole is regarded as one part, without division).

The second information is obtained by using a first method on the first information. The first information is at least one of a right singular vector of a spatial channel matrix or a spatial channel matrix. The first method is to perform scalar quantization on at least one element of the first information, a granularity of the scalar quantization is N bits, where a value range of N is 1, 2, . . . 20. The scalar quantization may be uniform scalar quantization or may be non-uniform scalar quantization. One example is to quantize each element of the right singular vector of the spatial channel matrix by using Float64.

In some implementations, the priority order of the second information may be set as follows:

In one CSI report, there is at most one second CSI. In the same CSI report, the priority order of the second information of the second CSI is given in a frequency domain. In some implementations, a base station configures the second CSI to be a subband report. The priority order of the second information is given by an index of a subband. For example, a priority order of the second information of subbands with odd-numbered indices is higher than a priority order of the second information of subbands with even-numbered indices. For another example, a priority order of the second information of subbands with odd-numbered indices is lower than a priority order of the second information of subbands with even-numbered indices. For a further example, a priority order of the second information of subbands with indices being m*K+1 is higher than a priority order of the second information of subbands with indices being m*K+2, further, a priority order of the second information of subbands with indices being m*K+2 is higher than a priority order of the second information of subbands with indices being m*K+3, . . . , a priority order of the second information of subbands with indices being m*K+m−1 is higher than a priority order of the second information of subbands with indices being m*K+m, where m and K are non-negative integers.

In some implementations, a priority order of the CSI report is higher than a priority order of the second information. That is to say, if a priority order of CSI report 1 is higher than a priority order of CSI report 2, the terminal equipment first transmits the entire content of the CSI report 1 to a base station and then transmits the content of the CSI report 2. An example is given in Table 1, in which at least a part of CSI report X is the second CSI, X is a positive integer with a value range 1, 2, . . . , N, and K in Table 1 is a non-negative integer.

TABLE 1

| | |
|---|---|
| Priority order 1 | Indices of CSI report 1 are the second |
| | information on the (3K + 1)th subband |
| Priority order 2 | Indices of CSI report 1 are the second |
| | information on the (3K + 2)th subband |
| Priority order 3 | Indices of CSI report 1 are the second |
| | information on the (3K + 3)th subband |
| Priority order 4 | Indices of CSI report 2 are the second |
| | information on the (3K + 1)th subband |
| Priority order 5 | Indices of CSI report 2 are the second |
| | information on the (3K + 2)th subband |
| Priority order 6 | Indices of CSI report 2 are the second |
| | information on the (3K + 3)th subband |
| Priority order 3N − 2 | Indices of CSI report N are the second |
| | information on the (3K + 1)th subband |
| Priority order 3N − 1 | Indices of CSI report N are the second |
| | information on the (3K + 2)th subband |
| Priority order 3N | Indices of CSI report N are the second |
| | information on the (3K + 3)th subband |

In some implementations, the priority order of the CSI report has no relation to the priority order of the second information. In other words, even if the priority order of CSI report 1 is higher than that of CSI report 2, the priority order of at least a part of CSI report 2 is higher than that of at least a part of the content in CSI report 1. An example is given in Table 2, in which at least a part of CSI report X is the second CSI, X is a positive integer with a value range 1, 2, . . . , N, and K in Table 1 is a non-negative integer.

TABLE 2

| Priority order 1 | Indices of CSI report 1 are the second |
|---|---|
| | information on the (4K + 1)th subband |
| Priority order 2 | Indices of CSI report 1 are the second |
| | information on the (4K + 3)th subband |
| Priority order 3 | Indices of CSI report 2 are the second |
| | information on the (4K + 1)th subband |
| Priority order 4 | Indices of CSI report 2 are the second |
| | information on the (4K + 3)th subband |
| . . . | |
| Priority order 2N − 1 | Indices of CSI report N are the second |
| | information on the (4K + 1)th subband |
| Priority order 2N | Indices of CSI report N are the second |
| | information on the (4K + 3)th subband |
| Priority order 2N + 1 | Indices of CSI report 1 are the second |
| | information on the (4K + 2)th subband |
| Priority order 2N + 2 | Indices of CSI report 1 are the second |
| | information on the (4K + 4)th subband |
| Priority order 2N + 3 | Indices of CSI report 2 are the second |
| | information on the (4K + 2)th subband |
| Priority order 2N + 4 | Indices of CSI report 2 are the second |
| | information on the (4K + 4)th subband |
| . . . | |
| Priority order 4N − 1 | Indices of CSI report N are the second |
| | information on the (4K + 2)th subband |
| Priority order 4N | Indices of CSI report N are the second |
| | information on the (4K + 4)th subband |

In some implementations, there may be only one CSI priority order, or there may be N priority orders, where N≥2. When there are N priority orders (N≥2), which CSI priority order to use may be configured by a network device or may be determined and reported by a terminal equipment. An example is given in Table 3, in which at least a part of CSI report X is the second CSI, X is a positive integer with a value range 1, 2, . . . , N, and K in Table 3 is a non-negative integer.

TABLE 3

| | #1 | #2 |
|---|---|---|
| Priority | Indices of CSI report 1 are | Indices of CSI report 1 are |
| order 1 | the second information on | the second information on |
| | the (3K + 1)th subband | odd-numbered subbands |
| Priority | Indices of CSI report 1 are | Indices of CSI report 1 are |
| order 2 | the second information on | the second information on |
| | the (3K + 2)th subband | even-numbered subbands |
| Priority | Indices of CSI report 1 are | Indices of CSI report 2 are |
| order 3 | the second information on | the second information on |
| | the (3K + 3)th subband | odd-numbered subbands |
| Priority | Indices of CSI report 2 are | Indices of CSI report 2 are |
| order 4 | the second information on | the second information on |
| | the (3K + 1)th subband | even-numbered subbands |
| Priority | Indices of CSI report 2 are | Indices of CSI report 3 are |
| order 5 | the second information on | the second information on |
| | the (3K + 2)th subband | odd-numbered subbands |
| Priority | Indices of CSI report 2 are | Indices of CSI report 3 are |
| order 6 | the second information on | the second information on |
| | the (3K + 3)th subband | even-numbered subbands |

. . .

| | | |
|---|---|---|
| Priority | Indices of CSI report N are | . . . |
| order | the second information on | |
| 3N − 2 | the (3K + 1)th subband | |
| Priority | Indices of CSI report N are | . . . |
| order | the second information on | |
| 3N − 1 | the (3K + 2)th subband | |
| Priority | Indices of CSI report N are | . . . |
| order | the second information on | |
| 3N | the (3K + 3)th subband | |

### Embodiment 2

Embodiment 2 describes situations in which the third rule is associated with spatial domain information.

In the implementations, the priority order of the second information of the second CSI is given in a spatial domain. It is assumed that the recommended number of downlink transmission layers for a terminal equipment is v, where v is a positive integer. In some implementations, a priority order of the CSI report is higher than a priority order of the second information. In other words, if a priority order of CSI report 1 is higher than a priority order of CSI report 2, the terminal equipment first transmits the entire content of the CSI report 1 to a network device and then transmits the content of the CSI report 2. An example is given in Table 4, in which at least a part of CSI report X is the second CSI, X is a positive integer with a value range 1, 2, . . . , N, and K in Table 4 is a non-negative integer.

TABLE 4

| | |
|---|---|
| Priority order 1 | Second information of a first spatial domain |
| | layer of CSI report 1 |
| Priority order 2 | Second information of a second spatial |
| | domain layer of CSI report 1 |

. . .

| | |
|---|---|
| Priority order v | Second information of a vth spatial domain |
| | layer of CSI report 1 |
| Priority order v + 1 | Second information of a first spatial domain |
| | layer of CSI report 2 |
| Priority order v + 2 | Second information of a second spatial |
| | domain layer of CSI report 2 |

. . .

| | |
|---|---|
| Priority order 2v | Second information of a vth spatial domain |
| | layer of CSI report 2 |

. . .

| | |
|---|---|
| Priority order (N − 1)v + 1 | Second information of a first spatial domain |
| | layer of CSI report N |
| Priority order (N − 1)v + 2 | Second information of a second spatial |
| | domain layer of CSI report N |

. . .

| | |
|---|---|
| Priority order Nv | Second information of a vth spatial domain |
| | layer of CSI report N |

In some implementations, the priority order of the CSI report has no relation to the priority order of the second information. In other words, even if the priority order of CSI report 1 is higher than that of CSI report 2, the priority order of at least a part of CSI report 2 is higher than that of at least a part of the content in CSI report 1. An example is given in Table 5, in which at least a part of CSI report X is the second CSI, X is a positive integer with a value range 1, 2, . . . , N, and K in Table 5 is a non-negative integer.

TABLE 5

| | |
|---|---|
| Priority order 1 | Second information of a first spatial domain |
| | layer of CSI report 1 |
| Priority order 2 | Second information of a first spatial domain |
| | layer of CSI report 2 |

. . .

| | |
|---|---|
| Priority order N | Second information of a first spatial domain |
| | layer of CSI report N |
| Priority order N + 1 | Second information of a second spatial |
| | domain layer of CSI report 1 |
| Priority order N + 2 | Second information of a second spatial |
| | domain layer of CSI report 2 |

. . .

| | |
|---|---|
| Priority order 2N | Second information of a second spatial |
| | domain layer of CSI report N |
| Priority order (v − 1)N + 1 | Second information of a vth spatial domain |
| | layer of CSI report 1 |
| Priority order (v − 1)N + 2 | Second information of a vth spatial domain |
| | layer of CSI report 2 |

. . .

| | |
|---|---|
| Priority order vN | Second information of a vth spatial domain |
| | layer of CSI report N |

Effect of the embodiment 2 is that: when collecting data for model training, a spatial domain layer may be used as a priority order criterion. In a spatial domain layer with a high SINR, a precoding vector (an approximation of a right singular vector of a spatial channel matrix) provides a more accurate description of a spatial channel compared to a spatial domain layer with a low SINR, using it as data for model training is more valuable for reference.

### Embodiment 3

Embodiment 3 describes situations in which the third rule is associated with both frequency domain information and spatial domain information.

In some implementations, in one CSI report, a priority level of a priority order of the second information in a spatial domain is higher than a priority level of a priority order of the second information in a frequency domain. An example is given in Table 6, in which at least a part of CSI report X is the second CSI, X is a positive integer with a value range 1, 2, . . . , N, and K in Table 6 is a non-negative integer. It is assumed that the recommended number of downlink transmission layers for a terminal equipment is v, where v is a positive integer.

TABLE 6

| | |
|---|---|
| Priority order 1 | Second information of odd-numbered |
| | subbands of a first spatial domain layer of |
| | CSI report 1 |
| Priority order 2 | Second information of even-numbered |
| | subbands of a first spatial domain layer of |
| | CSI report 1 |
| Priority order 3 | Second information of odd-numbered |
| | subbands of a second spatial domain layer |
| | of CSI report 1 |
| Priority order 4 | Second information of even-numbered |
| | subbands of a second spatial domain layer |
| | of CSI report 1 |

. . .

| | |
|---|---|
| Priority order 2v − 1 | Second information of odd-numbered |
| | subbands of a vth spatial domain layer of |
| | CSI report 1 |
| Priority order 2v | Second information of even-numbered |
| | subbands of a vth spatial domain layer of |
| | CSI report 1 |
| Priority order 2v + 1 | Second information of odd-numbered |
| | subbands of a first spatial domain layer of |
| | CSI report 2 |
| Priority order 2v + 2 | Second information of even-numbered |
| | subbands of a first spatial domain layer of |
| | CSI report 2 |
| Priority order 2v + 3 | Second information of odd-numbered |
| | subbands of a second spatial domain layer |
| | of CSI report 2 |
| Priority order 2v + 4 | Second information of even-numbered |
| | subbands of a second spatial domain layer |
| | of CSI report 2 |

. . .

| | |
|---|---|
| Priority order 4v − 1 | Second information of odd-numbered |
| | subbands of a vth spatial domain layer of |
| | CSI report 2 |
| Priority order 4v | Second information of even-numbered |
| | subbands of a vth spatial domain layer of |
| | CSI report 2 |

. . .

| | |
|---|---|
| Priority order 2(N − 1)v + 1 | Second information of odd-numbered |
| | subbands of a first spatial domain layer of |
| | CSI report N |
| Priority order 2(N − 1)v + 2 | Second information of even-numbered |
| | subbands of a first spatial domain layer of |
| | CSI report N |
| Priority order 2(N − 1)v + 3 | Second information of odd-numbered |
| | subbands of a second spatial domain layer |
| | of CSI report N |
| Priority order 2(N − 1)v + 4 | Second information of even-numbered |
| | subbands of a second spatial domain layer |
| | of CSI report N |

. . .

| | |
|---|---|
| Priority order 2Nv − 1 | Second information of odd-numbered |
| | subbands of a vth spatial domain layer of |
| | CSI report N |
| Priority order 2Nv | Second information of even-numbered |
| | subbands of a vth spatial domain layer of |
| | CSI report N |

In some implementations, in one CSI report, a priority level of a priority order of the second information in a frequency domain is higher than a priority level of a priority order of the second information in a spatial domain. In some implementations, in at least one CSI report, a priority order of the CSI reports is higher than a priority order of the second information. In some implementations, in at least one CSI report, the priority order of the CSI reports has no relation to the priority order of the second information. In other words, even if the priority order of CSI report 1 is higher than that of CSI report 2, the priority order of at least a part of CSI report 2 is higher than that of at least a part of the content in CSI report 1. Specific instances may be provided similar to those in Table 6 and are not elaborated here.

### Embodiment 4

Embodiment 4 illustrates the fourth rule (such as a priority order of the third information). In the same third CSI of the same CSI report, the fourth rule of the third CSI is associated with spatial domain information.

In some implementations, the third information includes two or more groups, at least one of the groups including spatial domain layer information, and the fourth rule includes obtaining an order of the two or more groups according to the spatial domain information and/or information of the groups.

In some implementations, the information of the groups includes at least one of an index, a bitmap, a number or an identifier.

In some implementations, the fourth rule is a mapping of an order of the information of the groups, wherein for the same information of the groups, the fourth rule is a mapping of an order of the spatial domain information; or the fourth rule is a mapping of an order of the spatial domain information, wherein for the same spatial domain information, the fourth rule is a mapping of an order of the information of the groups.

In some implementations, the order is at least one of a priority order, a report order or a priority level.

In some implementations, for two or more of the CSI reports, the rule further includes that: the second rule takes precedence over the fourth rule, or, the fourth rule takes precedence over the second rule; or, the second rule and the fourth rule are independent of each other.

The fourth rule is further described below.

In some implementations, at least a part of the third CSI is third information. The third CSI may further include a rank indicator (RI) or may not include the RI. For the former (including the RI), the third CSI may be divided into at least two parts, and in some implementations, assuming that there are only two parts, a first part of CSI (Part 1 CSI) at least includes the RI. A second part of CSI (Part 2 CSI) includes at least a part of the third information. For the latter (not including the RI), the third CSI may also be divided into at least two parts, and in some implementations, assuming that there are only two parts, the second part of CSI (Part 2 CSI) includes the third information. A first part of CSI (Part 1 CSI) includes fourth information; the fourth information is at least a part of information that determines a bit width of the third information.

The third information is obtained by using a second method on the first information. The second method is a method obtained by expanding a value range of at least one parameter of a first codebook. The first codebook as well as parameters and a value range of the first codebook are given in Section 3GPP TS 38.214 V17.6.0 5.2.2.2.

The first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook.

In some implementations, for the priority order of the third information, relevant technologies may be referred to.

In some other implementations, the priority order of the third information may be:
in one CSI report, there is at most one piece of third CSI. In the same CSI report, the priority order of the third CSI may be as follows. In the implementations, the priority order of the third CSI is given in a spatial domain. It is assumed that the recommended number of downlink transmission layers for a terminal equipment is v, where v is a positive integer. In some implementations, a priority order of the CSI report is higher than a priority order of the third information. In other words, if a priority order of CSI report 1 is higher than a priority order of CSI report 2, the terminal equipment first transmits the entire content of the CSI report 1 to a network device and then transmits the content of the CSI report 2. In some implementations, the third information is divided into at least two groups, among which at least one group includes information of a spatial domain layer. For example, the method obtained by expanding a value range of at least one parameter of the enhanced Type II codebook may be grouped as follows:
Group 0: indices i_{1,1} (if reported to a network device), i_{1,2} (if reported to a network device), i_{1,5} (if reported to a network device) including a precoding matrix indicator (PMI).
Group 1: at least a part of indices i_{1,8,l}, i_{1,6,l} (if reported to a network device) and i_{1,7,l}, at least a part of i_{2,3,l}, i_{2,4,l}, at least a part of i_{2,5,l}, the indices including a PMI.
Group 2: the remaining part of index i_{1,7,l}, the remaining part of i_{2,4,l} and the remaining part of i_{2,5,l}, the indices including a PMI.

For l in Group 1 and Group 2, its meaning is a spatial domain layer. It is assumed that the recommended number of downlink transmission layers for a terminal equipment is v, vis a positive integer, a value of l is 1, 2, . . . , v. In some examples, at least a part of i_{1,7,l} in Group 1 is

$${v 2 LM}_{v} - ⌊ \frac{{K}^{NZ}}{2} ⌋$$

elements with the first rule being high, at least a part of i_{2,4,l} is

$$max ( 0 , ⌈ \frac{{K}^{NZ}}{2} ⌉ - v )$$

elements with the first rule being high, and at least a part of i_{2,5,l} is

$$max ( 0 , ⌈ \frac{{K}^{NZ}}{2} ⌉ - v )$$

elements with the first rule being high. The first rule is that an element with a small value of the function Pri(l,i,f) has a high first rule, wherein the definitions of the function Pri(l,i,f) and its independent variables are given in Section 5.2.3 of 3GPP TS 38.214 V17.6.0. For parameter

$${M}_{v} = ⌈ {p}_{v} \frac{{N}_{3}}{R} ⌉ , {K}^{NZ}$$

satisfies:

$${K}^{NZ} = {\sum }_{l = 1}^{v} {K}_{l}^{NZ} \leq 2 {K}_{0} ,$$

$${K}_{l}^{NZ} = {\sum }_{i = 1}^{2 L - 1} {\sum }_{f = 1}^{{M}_{v} - 1} {k}_{l , i , f}^{( 3 )} \leq {K}_{0} ,$$

$${K}_{0} = ⌈ β 2 {LM}_{1} ⌉ ,$$

$${M}_{1} = ⌈ {p}_{1} \frac{{N}_{3}}{R} ⌉$$

Definitions of parameters

$${N}_{3} , R , L , {p}_{v} , {p}_{1} , {K}^{NZ} , {K}_{l}^{NZ} , {k}_{l , i , f}^{( 3 )} , {K}_{0} , β , {M}_{v} , {M}_{v}$$

are given in Section 5.2.3 of 3GPP TS 38.214 V17.6.0. Values of parameter

$${N}_{3} , R , {k}_{l , i , f}^{( 3 )}$$

are given in Section 5.2.2 of 3GPP TS 38.214 V17.6.0. Value ranges of parameters L, pᵥ, p₁, β is obtained by expanding value ranges of L, pᵥ, p₁, β, v specified in the enhanced Type II codebook, some examples are Table A and Table B.

TABLE A
Changing a value range of at least one parameter of the
enhanced Type II codebook

| | | pᵥ | | |
|---|---|---|---|---|
| paramCombination-r16-revise | L | v ∈ {1, 2} | v ∈ {3, 4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | — | ½ |
| 8 | 6 | ¼ | — | ¾ |
| 9 | 6 | ¼ | ¼ | ½ |
| 10 | 7 | ½ | ¼ | ¾ |
| 11 | 8 | 0.9 | — | ⅘ |
| 12 | 5 | ½ | ¼ | ¼ |

TABLE B
Changing a value range of at least one parameter of the
enhanced Type II codebook

| paramCombination- | | pᵥ | | | |
|---|---|---|---|---|---|
| r16-revise | L | v ∈ {1, 2} | v ∈ {3, 4} | v ∈ {5, 6} | β |
| 1 | 2 | ¼ | ⅛ | — | ¼ |
| 2 | 2 | ¼ | ⅛ | — | ½ |
| 3 | 4 | ¼ | ⅛ | — | ¼ |
| 4 | 4 | ¼ | ⅛ | ⅛ | ¾ |
| 5 | 4 | ¼ | ¼ | — | ¾ |
| 6 | 4 | ½ | ¼ | — | ½ |
| 7 | 6 | ¼ | ⅛ | ⅛ | ½ |
| 8 | 6 | ¼ | ¼ | ¼ | ¾ |

Examples of changing a value range (including R, N₃, reference amplitude quantization accuracy, differential amplitude quantization accuracy, phase quantization accuracy) of at least one parameter of the enhanced Type II codebook are given in Table C.

TABLE C
changing a value range of at least one
parameter of the enhanced Type II codebook.

| | | | | | Reference | Differential | |
|---|---|---|---|---|---|---|---|
| | | | | | amplitude | amplitude | Phase |
| | | | | | quantization | quantization | quantization |
| L | pᵥ | β | N₃ | R | accuracy | accuracy | accuracy |
| 6 | 0.25 | 0.75 | 39 | 3 | 4 bits | 3 bits | 4 bits |

An example of the priority order of the third information is given in Table 7, in which at least a part of CSI report X is the third CSI, X is a positive integer with a value range 1, 2, . . . , N, and K in Table 7 is a non-negative integer. In this example, the second method is a method obtained by expanding a value range of at least one parameter of the enhanced Type II codebook. In this example, the third information is Part 2 CSI provided in Section 5.2 of the protocol 3GPP TS 38.214 V17.6.0, i.e., in this example, expanding a value range of at least one parameter of the enhanced Type II codebook does not change a division method for Part 1 and Part 2 of CSI.

TABLE 7

| | |
|---|---|
| Priority order 0 | Group 0 (if any) of the third information |
| | from CSI report 1 to CSI report N |
| Priority order 1 | First spatial domain layer (l = 1) of |
| | Group 1 of the third information of CSI |
| | report 1 |
| Priority order 2 | First spatial domain layer (l = 1) of |
| | Group 2 of the third information of CSI |
| | report 1 |
| Priority order 3 | Second spatial domain layer (l = 2) of |
| | Group 1 of the third information of CSI |
| | report 1 |
| Priority order 4 | Second spatial domain layer (l = 2) of |
| | Group 2 of the third information of CSI |
| | report 1 |

. . .

| | |
|---|---|
| Priority order 2v − 1 | Vth spatial domain layer (l = v) of Group |
| | 1 of the third information of CSI report 1 |
| Priority order 2v | Vth spatial domain layer (l = v) of Group |
| | 2 of the third information of CSI report 1 |
| Priority order 2v + 1 | First spatial domain layer (i = 1) of |
| | Group 1 of the third information of CSI |
| | report 2 |
| Priority order 2v + 2 | First spatial domain layer (l = 1) of |
| | Group 2 of the third information of CSI |
| | report 2 |
| Priority order 2v + 3 | Second spatial domain layer (l = 2) of |
| | Group 1 of the third information of CSI |
| | report 2 |
| Priority order 2v + 4 | Second spatial domain layer (l = 2) of |
| | Group 2 of the third information of CSI |
| | report 2 |

. . .

| | |
|---|---|
| Priority order 4v − 1 | Vth spatial domain layer (l = v) of Group |
| | 1 of the third information of CSI report 2 |
| Priority order 4v | Vth spatial domain layer (l = v) of Group |
| | 2 of the third information of CSI report 2 |

. . .

| | |
|---|---|
| Priority order 2(N − 1)v + 1 | First spatial domain layer () = 1) of |
| | Group 1 of the third information of CSI |
| | report N |
| Priority order 2(N − 1)v + 2 | First spatial domain layer (l = 1) of |
| | Group 2 of the third information of CSI |
| | report N |
| Priority order 2(N − 1)v + 3 | Second spatial domain layer (l = 2) of |
| | Group 1 of the third information of CSI |
| | report N |
| Priority order 2(N − 1)v + 4 | Second spatial domain layer (l = 2) of |
| | Group 2 of the third information of CSI |
| | report N |

. . .

| | |
|---|---|
| Priority order 2Nv − 1 | Vth spatial domain layer (l = v) of Group |
| | 1 of the third information of CSI report N |
| Priority order 2Nv | Vth spatial domain layer (l = v) of Group |
| | 2 of the third information of CSI report N |

Priority orders are not limited to Table 7, there may further be other combinations.

### Embodiment 5

Embodiment 5 describes the first rule. At least one CSI report includes at least two types of CSI among the first CSI, the second CSI, the third CSI and the fourth CSI, the at least two types of CSI having the first rule.

In some implementations, a terminal equipment transmits at least two of the first CSI, the second CSI (Example 1), the third CSI (Example 4) and the fourth CSI to a network device. The first CSI is CSI obtained via a third method, and at least a part of the third method is an artificial intelligence model based method. The fourth CSI is CSI obtained via a fourth method, and at least a part of the fourth method is the first codebook. The first CSI is associated with at least one CSI-RS resource; and/or the second CSI is associated with at least one CSI-RS resource; and/or the third CSI associated with at least one CSI-RS resource; and/or the fourth CSI is associated with at least one CSI-RS resource. Priority order for transmitting these four pieces of CSI is a first rule.

In some implementations, if two or more of these four pieces of CSI are in one CSI report (at this point, the “two or more” are generated based on at least a part of the same channel state information reference signal (CSI-RS) and/or CSI-RS resource), it may be defined as a first rule. For example, the first rule of the first CSI is higher than that of the second CSI, and the first rule of the second CSI is higher than that of the fourth CSI. For another example, the first rule of the first CSI is higher than that of the third CSI, and the first rule of the third CSI is higher than that of the fourth CSI. Other first rules may further be given.

### Embodiment 6

Embodiment 6 illustrates a combination of at least two of the first rule, the second rule, the third rule and the fourth rule.

In some embodiments, at least one of the first CSI, the second CSI or the third CSI includes a first part and a second part, the first part including at least a part of information of ranks of a spatial channel matrix and/or information of channel quality, and/or information of layers. The information of ranks of the spatial channel matrix is a rank indicator (RI), the information of channel quality is a channel quality indicator (CQI), and the information of layers is a layer indicator (LI).

The rank indicators of the first CSI, the second CSI, the third CSI and the fourth CSI are the same, the terminal equipment reports one of the rank indicators; or, rank indicators of at least two of the first CSI, the second CSI, the third CSI and the fourth CSI are different, the terminal equipment reports the rank indicators of at least two of them or a different rank indicator, for example if there are three RIs, and values corresponding to RIs are 2, 2, 4 respectively, the terminal equipment may report 2, 2, 4 (that is, report the rank indicators of at least two of them), or the terminal equipment may report 2, 4 (that is, report the different rank indicator).

In some embodiments, at least a part of the second part is precoding matrix information. The third rule or the fourth rule in the present disclosure may be used to indicate a priority order of the second part.

In some embodiments, the number of the CSI reports is at least two, a rule used by the terminal equipment is associated with the second rule, the first rule, the third rule or the fourth rule; or, in one of the CSI reports, a rule used by the terminal equipment is associated with the first rule, the third rule or the fourth rule.

For example, the number of the CSI reports is at least two, and a rule used by the terminal equipment is that:
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.

For another example, in one of the CSI reports, a rule used by the terminal equipment is that:
the first rule takes precedence over the third rule or the fourth rule; or
the third rule or the fourth rule takes precedence over the first rule.

Embodiment 6 is illustrated below.

In some implementations, a terminal equipment transmits at least one CSI report to a network device, each CSI report including at least part of information of the first CSI, at least part of information of the second CSI, at least part of information of the third CSI, and at least part of information of the fourth CSI, two or more of these four pieces of CSI are denoted as tenth information. Each CSI report may be divided into two parts. At least part of information in a first part of CSI (Part 1 CSI) is a rank indicator of a spatial channel matrix, the rank indicator may be the same for the first CSI, the second CSI, the third CSI and the fourth CSI, and at this point, only one rank indicator needs to be reported. The rank indicator may further be different for at least two of the first CSI, the second CSI, the third CSI and the fourth CSI, this difference may be configured by the network device or may be stipulated by the Standard, and at this point, at least one rank indicator needs to be reported. At least a part of the second part of CSI is precoding matrix information of the first CSI, the second CSI, the third CSI and the fourth CSI respectively. Priority order stipulated for the second part of CSI is called a third rule. The tenth information is generated based on at least a part of the same channel state information reference signal (CSI-RS) and/or CSI-RS resource.

In some implementations, a rule used by the terminal equipment may be as follows:
if a priority level of CSI report A is higher than that of CSI report B, a priority order of any part in CSI report A is higher than that of any part in CSI report B; and
in one CSI report, a report order may be first stipulated for the tenth information according to the first rule (Embodiment 5), and then the report order may be stipulated according to respective priority orders of the tenth information (for example, including the priority orders described in Embodiments 1 to 4, or other priority orders).

Assuming that the second part of CSI I (denoted as eleventh information) of the first CSI is in the second part of CSI of the tenth information, the eleventh information has three priority orders. The second information of the second CSI includes two priority orders. The third information of the third CSI includes two priority orders, the second part of CSI (denoted as fourteenth information) of the fourth CSI is in the second part of CSI of the tenth information, the fourteenth information has two priority orders, as shown in the following Table 8.

TABLE 8

| Report order 1 | Priority order 1 of the eleventh information |
|---|---|
| | of CSI report 1 |
| Report order 2 | Priority order 2 of the eleventh information |
| | of CSI report 1 |
| Report order 3 | Priority order 3 of the eleventh information |
| | of CSI report 1 |
| Report order 4 | Priority order 1 of the second information of |
| | CSI report 1 |
| Report order 5 | Priority order 2 of the second information of |
| | CSI report 1 |
| Report order 6 | Priority order 1 of the eleventh information |
| | of CSI report 2 |
| Report order 7 | Priority order 2 of the eleventh information |
| | of CSI report 2 |
| Report order 8 | Priority order 3 of the eleventh information |
| | of CSI report 2 |
| Report order 9 | Priority order 1 of the second information of |
| | CSI report 2 |
| Report order 10 | Priority order 2 of the second information of |
| | CSI report 2 |
| . . . | |
| Report order 5N − 4 | Priority order 1 of the eleventh information |
| | of CSI report N |
| Report order 5N − 3 | Priority order 2 of the eleventh information |
| | of CSI report N |
| Report order 5N − 2 | Priority order 3 of the eleventh information |
| | of CSI report N |
| Report order 5N − 1 | Priority order 1 of the second information of |
| | CSI report N |
| Report order 5N | Priority order 2 of the second information of |
| | CSI report N |

In some implementations, a rule used by the terminal equipment may be as follows:

A report order is first stipulated for the tenth information according to the first rule (Embodiment 5) For example, a priority order of the first CSI in any CSI report is higher than that of the second CSI in any CSI report.

An internal priority order of at least a part of the first CSI, an internal priority order of at least a part of the second CSI, an internal priority order of at least a part of the third CSI and an internal priority order of at least a part of the fourth CSI are stipulated (for example, by the priority orders described in Embodiments 1 to 4 or other priority orders).

The report order is then stipulated according to priority levels of CSI reports.

As shown in the following Table 9.

TABLE 9

| | |
|---|---|
| Report order 1 | Priority order 1 of the eleventh information of |
| | CSI report 1 |
| Report order 2 | Priority order 2 of the eleventh information of |
| | CSI report 1 |
| Report order 3 | Priority order 3 of the eleventh information of |
| | CSI report 1 |
| Report order 4 | Priority order 1 of the eleventh information of |
| | CSI report 2 |
| Report order 5 | Priority order 2 of the eleventh information of |
| | CSI report 2 |
| Report order 6 | Priority order 3 of the eleventh information of |
| | CSI report 2 |

. . .

| | |
|---|---|
| Report order 3N − 2 | Priority order 1 of the eleventh information of |
| | CSI report N |
| Report order 3N − 1 | Priority order 2 of the eleventh information of |
| | CSI report N |
| Report order 3N | Priority order 3 of the eleventh information of |
| | CSI report N |
| Report order 3N + 1 | Priority order 1 of the second information of |
| | CSI report 1 |
| Report order 3N + 2 | Priority order 2 of the second information of |
| | CSI report 1 |
| Report order 3N + 3 | Priority order 1 of the second information of |
| | CSI report 2 |
| Report order 3N + 4 | Priority order 2 of the second information of |
| | CSI report 2 |
| . . . | |
| Report order 5N − 1 | Priority order 1 of the second information of |
| | CSI report N |
| Report order 5N | Priority order 2 of the second information of |
| | CSI report N |

In some implementations, a rule used by the terminal equipment may be as follows:

A report order is first stipulated for the tenth information according to the first rule (Embodiment 5) For example, a priority order of the first CSI in any CSI report is higher than that of the second CSI in any CSI report.

The report order is then stipulated according to priority levels of CSI reports.

Finally, an internal priority order of the eleventh information, an internal priority order of the second information, an internal priority order of the third information and an internal priority order of the fourteenth information, and Embodiments 1 to 4 or other rules are followed.

As shown in the following Table 10.

TABLE 10

| Report order 1 | Priority order 1 of the eleventh information |
|---|---|
| | of CSI report 1 |
| Report order 2 | Priority order 1 of the eleventh information |
| | of CSI report 2 |
| . . . | |
| Report order N | Priority order 1 of the eleventh information |
| | of CSI report N |
| Report order N + 1 | Priority order 2 of the eleventh information |
| | of CSI report 1 |
| Report order N + 2 | Priority order 2 of the eleventh information |
| | of CSI report 2 |
| Report order 2N | Priority order 2 of the eleventh information |
| | of CSI report N |
| Report order 2N + 1 | Priority order 3 of the eleventh information |
| | of CSI report 1 |
| Report order 2N + 2 | Priority order 3 of the eleventh information |
| | of CSI report 2 |
| . . . | |
| Report order 3N | Priority order 3 of the eleventh information |
| | of CSI report N |
| Report order 3N + 1 | Priority order 1 of the second information of |
| | CSI report 1 |
| Report order 3N + 2 | Priority order 1 of the second information of |
| | CSI report 2 |
| . . . | |
| Report order 4N | Priority order 1 of the second information of |
| | CSI report N |
| Report order 4N + 1 | Priority order 2 of the second information of |
| | CSI report 1 |
| Report order 4N + 2 | Priority order 2 of the second information of |
| | CSI report 2 |
| . . . | |
| Report order 5N | Priority order 2 of the second information of |
| | CSI report N |

Or priority levels of CSI reports are removed, the above example may be changed to be shown in the following Table 11.

TABLE 11

| | |
|---|---|
| Report order 1 | Priority order 1 of the eleventh information |
| | of CSI report 1 to CSI report N |
| Report order 2 | Priority order 2 of the eleventh information |
| | of CSI report 1 to CSI report N |
| Report order 3 | Priority order 3 of the eleventh information |
| | of CSI report 1 to CSI report N |
| Report order 4 | Priority order 1 of the second information of |
| | CSI report 1 to CSI report N |
| Report order 5 | Priority order 2 of the second information of |
| | CSI report 1 to CSI report N |

In some implementations, a rule used by the terminal equipment is as follows:

First, an internal priority order of the eleventh information, an internal priority order of the second information, an internal priority order of the third information and an internal priority order of the fourteenth information, and Embodiments 1 to 4 or other rules are followed.

The first rule is then followed.

Finally, priority levels of CSI reports are followed.

As shown in the following Table 12.

TABLE 12

| | |
|---|---|
| Report order 1 | Priority order 1 of the eleventh information of |
| | CSI report 1 |
| Report order 2 | Priority order 1 of the eleventh information of |
| | CSI report 2 |
| . . . | |
| Report order N | Priority order 1 of the eleventh information of |
| | CSI report N |
| Report order N + 1 | Priority order 1 of the second information of |
| | CSI report 1 |
| Report order N + 2 | Priority order 1 of the second information of |
| | CSI report 2 |

. . .

| | |
|---|---|
| Report order 2N | Priority order 1 of the second information of |
| | CSI report N |
| Report order 2N + 1 | Priority order 2 of the eleventh information of |
| | CSI report 1 |
| Report order 2N + 2 | Priority order 2 of the eleventh information of |
| | CSI report 2 |

. . .

| | |
|---|---|
| Report order 3N | Priority order 2 of the eleventh information of |
| | CSI report N |
| Report order 3N + 1 | Priority order 2 of the second information of |
| | CSI report 1 |
| Report order 3N + 2 | Priority order 2 of the second information of |
| | CSI report 2 |

. . .

| | |
|---|---|
| Report order 4N | Priority order 2 of the second information of |
| | CSI report N |
| Report order 4N + 1 | Priority order 3 of the eleventh information of |
| | CSI report 1 |
| Report order 4N + 2 | Priority order 3 of the eleventh information of |
| | CSI report 2 |
| . . . | |
| Report order 5N | Priority order 3 of the eleventh information of |
| | CSI report N |

Or priority levels of CSI reports are removed, for example the above example may be changed to be shown in the following Table 13.

TABLE 13

| | |
|---|---|
| Report order 1 | Priority order 1 of the eleventh information of |
| | CSI report 1 to CSI report N |
| Report order 2 | Priority order 1 of the second information of |
| | CSI report 1 to CSI report N |
| Report order 3 | Priority order 2 of the eleventh information of |
| | CSI report 1 to CSI report N |
| Report order 4 | Priority order 2 of the second information of |
| | CSI report 1 to CSI report N |
| Report order 5 | Priority order 3 of the eleventh information of |
| | CSI report 1 to CSI report N |

The above text describes the embodiments of the first aspect in combination with Embodiments 1 to 6. The Embodiments 1 to 6 may be combined. Technical solution of the present disclosure may not be limited to the Embodiments 1 to 6.

According to the embodiments of the first aspect of the present disclosure, a terminal equipment transmits part or all of at least one CSI report to a network device according to a rule, whereby in a case where resources of an uplink channel (a PUCCH and/or a PUSCH) are limited, the terminal equipment may discard CSI according to the rule, which not only makes reasonable use of the resources of the uplink channel, but also avoids ambiguity that may occur when the network device reads the CSI.

Embodiments of the first aspect of the present disclosure further provide a method for stipulating rank indicators in a case where the CSI report includes at least one of the first CSI, the second CSI, the third CSI or the fourth CSI. The embodiments of the first aspect of the present disclosure provide that a terminal equipment flexibly reports the number of spatial domain layers of CSI as needed. For example, for collection of the second information (which may be used for AI/ML model monitoring and/or AI/ML model training) by the network device, even if a value corresponding to an RI of the first CSI is greater than 1, the terminal equipment may, (according to a configuration of the network device, or Standard provisions, or the terminal equipment decides and reports to the network device), only report the second information of one spatial domain layer (the strongest spatial domain layer). Since the strongest spatial domain layer of the second information trains an AI/ML model to depict spatial channel characteristics more accurately compared to the remaining spatial domain layers of the second information, only reporting the second information of the strongest spatial domain layer may save overhead and channel resources.

### Embodiments of a Second Aspect

Embodiments of a second aspect provide a method for receiving channel state information (CSI), applicable to a network device, such as the network device 201 in FIG. 2. For the parts of the embodiments of the second aspect that are the same as those of the first aspect, the description in the embodiments of the first aspect may be referred to, and will not be repeated here.

FIG. 4 is a schematic diagram of a method for receiving channel state information in the embodiments of a second aspect. The method includes:
401, the network device receives part or all of at least one channel state information (CSI) report transmitted by a terminal equipment based on a rule, the CSI report including at least one of first CSI, second CSI or third CSI.

In at least one embodiment, the CSI report further includes fourth CSI.

In at least one embodiment, the rule is configured by the network device; or, the rule is determined by the terminal equipment, and the terminal equipment may transmit the determined rule to the network device; or, the rule is predefined.

For example, the terminal equipment receives information for indicating available rules for the terminal equipment and configured by the network device, when the number of the available rule indicated by the information is one, the rule is the one available rule; or, when the number of the available rules indicated by the information is more than two, the rule is determined by the terminal equipment from the at least two available rules.

In at least one embodiment, the CSI report is associated with at least one CSI-RS (channel state information reference signal) resource.

In at least one embodiment:
precoding matrix information of the first CSI is generated by an artificial intelligence model; and/or
at least a part of the second CSI is second information, the second information being obtained by performing scalar quantization on one or more elements of a right singular vector of a spatial channel matrix and/or of a eigenvector of the spatial channel matrix and/or of the spatial channel matrix; and/or
at least a part of the fourth CSI is precoding matrix information obtained by applying a first codebook to the right singular vector of the spatial channel matrix and/or the eigenvector of the spatial channel matrix; and/or
at least a part of the third CSI is third information, the third information being precoding matrix information obtained by applying a codebook obtained by expanding a value range of at least one parameter of the first codebook, to the right singular vector of the spatial channel matrix and/or the eigenvector of the spatial channel matrix.

In at least one embodiment, the rule includes at least one of a first rule, a second rule, a third rule or a fourth rule, wherein:
the first rule is an order corresponding to CSI types; and/or
the second rule is an order of the CSI reports; and/or
the third rule is an order of the second information in each CSI report; and/or
the fourth rule is an order of the third information in each CSI report.

In at least one embodiment, the order is at least one of a priority order, a report order or a priority level.

In at least one embodiment, the first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook.

In at least one embodiment, in one piece of the second CSI of one of the CSI reports, the third rule is associated with frequency domain information and/or spatial domain information.

In at least one embodiment, the frequency domain information includes information of subbands and/or information of subcarriers and/or information of bandwidths;
the spatial domain information includes information of spatial domain layers and/or information of antenna ports.

In at least one embodiment, the information of subbands and/or information of subcarriers and/or information of bandwidths and/or the information of spatial domain layers and/or information of antenna ports include(s) at least one of an index, a bitmap or an identifier.

In at least one embodiment, for two or more of the CSI reports, the rule further includes that:
the second rule takes precedence over the third rule; or
the third rule takes precedence over the second rule; or
the second rule and the third rule are independent of each other.

In at least one embodiment, the third rule is a mapping of an order of the frequency domain information, wherein for the same frequency domain information, the third rule is a mapping of an order of the spatial domain information; or
the third rule is a mapping of an order of the spatial domain information, wherein for the same spatial domain information, the third rule is a mapping of an order of the frequency domain information.

In at least one embodiment, the order is at least one of a priority order, a report order or a priority level.

In at least one embodiment, in the same third CSI of the same CSI report, the fourth rule of the third CSI is associated with spatial domain information.

In at least one embodiment, the third information includes two or more groups, at least one of the groups including spatial domain layer information, and the fourth rule includes obtaining an order of the two or more groups according to the spatial domain information and/or information of the groups.

In at least one embodiment, the information of the groups includes at least one of an index, a bitmap, a number or an identifier.

In at least one embodiment, the fourth rule is a mapping of an order of the information of the groups, wherein for the same information of the groups, the fourth rule is a mapping of an order of the spatial domain information; or
the fourth rule is a mapping of an order of the spatial domain information, wherein for the same spatial domain information, the fourth rule is a mapping of an order of the information of the groups.

In at least one embodiment, the order is at least one of a priority order, a report order or a priority level.

In at least one embodiment, for two or more of the CSI reports, the rule further includes that:
the second rule takes precedence over the fourth rule; or
the fourth rule takes precedence over the second rule; or
the second rule and the fourth rule are independent of each other.

In at least one embodiment, at least one of the CSI reports includes at least two types of CSI among the first CSI, the second CSI, the third CSI and the fourth CSI, the at least two types of CSI having the first rule.

In at least one embodiment, at least one of the first CSI, the second CSI or the third CSI includes a first part and a second part, the first part including at least a part of information of ranks of a spatial channel matrix and/or information of channel quality, and/or information of layers.

In at least one embodiment, the information of ranks of the spatial channel matrix is a rank indicator (RI).

In at least one embodiment, the information of channel quality is a channel quality indicator (CQI).

In at least one embodiment, the information of layers is a layer indicator (LI).

In at least one embodiment, rank indicators of the first CSI, the second CSI, the third CSI and the fourth CSI are the same, the network device receives one of the rank indicators reported by the terminal equipment; or, rank indicators of at least two of the first CSI, the second CSI, the third CSI and the fourth CSI are different, the network device receives the at least two of the rank indicators or different rank indicators reported by the terminal equipment.

In at least one embodiment, at least a part of the second part is precoding matrix information.

In at least one embodiment, the number of the CSI reports is at least two, the rule is associated with the second rule, the first rule, the third rule or the fourth rule; or, in one of the CSI reports, the rule is associated with the first rule and the third rule or the fourth rule.

In at least one embodiment, the number of the CSI reports is at least two, and the rule is that:
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.

In at least one embodiment, in one of the CSI reports, the rule is that:
the first rule takes precedence over the third rule or the fourth rule; or
the third rule or the fourth rule takes precedence over the first rule.

In at least one embodiment, the network device configures information of the rule, the information including an index and/or a number and/or a bitmap of the rule; and/or
the network device receives information of the determined rule from the terminal equipment, the information including an index and/or a number and/or a bitmap of the rule.

### Embodiments of a Third Aspect

At least for the same problem as that in the embodiments of the first aspect, the embodiments of a first aspect of the present disclosure provide an apparatus for transmitting channel state information, applicable to a terminal equipment and corresponding to the embodiments of the first aspect.

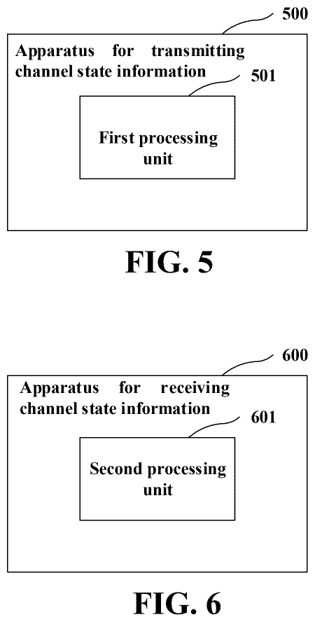

FIG. 5 is a schematic diagram of an apparatus for transmitting channel state information (CSI) in the embodiments of a third aspect. As shown in FIG. 5, an apparatus 500 for transmitting channel state information (CSI) includes a first processing unit 501.

The first processing unit 501 enables the terminal equipment to perform the following operations:
generating at least one channel state information (CSI) report, the CSI report including at least one of first CSI, second CSI or third CSI; and
transmitting part or all of at least one of the CSI reports to a network device according to a rule.

In at least one embodiment, the CSI report further includes fourth CSI.

In at least one embodiment, the rule is configured by the network device; or, the rule is determined by the terminal equipment, and the terminal equipment may transmit the rule that is determined to the network device; or, the rule is predefined.

In at least one embodiment, the terminal equipment receives information for indicating available rules for the terminal equipment and configured by the network device, wherein the number of the available rules indicated by the information is one, the rule is the one available rule; or, the number of the available rules indicated by the information is more than two, the rule is determined by the terminal equipment from the at least two available rules.

In at least one embodiment, the CSI report is associated with at least one CSI-RS resource.

In at least one embodiment, precoding matrix information of the first CSI is generated by an artificial intelligence model; and/or
at least a part of the second CSI is second information, the second information being obtained by performing scalar quantization on one or more elements of a right singular vector of a spatial channel matrix and/or of a eigenvector of the spatial channel matrix and/or of the spatial channel matrix; and/or
at least a part of the fourth CSI is precoding matrix information obtained using a first codebook, for the right singular vector of the spatial channel matrix and/or the eigenvector of the spatial channel matrix; and/or
at least a part of the third CSI is third information, the third information being precoding matrix information obtained by applying a codebook obtained by expanding a value range of at least one parameter of the first codebook to the right singular vector of the spatial channel matrix and/or the eigenvector of the spatial channel matrix.

In at least one embodiment, the rule includes at least one of a first rule, a second rule, a third rule or a fourth rule, in the embodiment:
the first rule is an order corresponding to CSI types; and/or
the second rule is an order of the CSI reports; and/or
the third rule is an order of the second information in each CSI report; and/or
the fourth rule is an order of the third information in each CSI report.

In at least one embodiment, the order is at least one of a priority order, a report order or a priority level.

In at least one embodiment, the first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook.

In at least one embodiment, in one piece of the second CSI of one of the CSI reports, the third rule is associated with frequency domain information and/or spatial domain information.

In at least one embodiment, the frequency domain information includes information of subbands and/or information of subcarriers and/or information of bandwidths;
the spatial domain information includes information of spatial domain layers and/or information of antenna ports.

In at least one embodiment, the information of subbands and/or information of subcarriers and/or information of bandwidths and/or the information of spatial domain layers and/or information of antenna ports include(s) at least one of an index, a bitmap or an identifier.

In at least one embodiment, for two or more of the CSI reports, the rule further includes that:
the second rule takes precedence over the third rule; or
the third rule takes precedence over the second rule; or
the second rule and the third rule are independent of each other.

In at least one embodiment, the third rule is a mapping of an order of the frequency domain information, wherein for the same frequency domain information, the third rule is a mapping of an order of the spatial domain information; or
the third rule is a mapping of an order of the spatial domain information, wherein for the same spatial domain information, the third rule is a mapping of an order of the frequency domain information.

In at least one embodiment, the order is at least one of a priority order, a report order or a priority level.

In at least one embodiment, in the same third CSI of the same CSI report, the fourth rule of the third CSI is associated with spatial domain information.

In at least one embodiment, the third information includes two or more groups, at least one of the groups including spatial domain layer information, and the fourth rule includes: obtaining an order of the two or more groups according to the spatial domain information and/or information of the groups.

In at least one embodiment, the information of the groups includes at least one of an index, a bitmap, a number or an identifier.

In at least one embodiment, the fourth rule is a mapping of an order of the information of the groups, wherein for the same information of the groups, the fourth rule is a mapping of an order of the spatial domain information; or
the fourth rule is a mapping of an order of the spatial domain information, wherein for the same spatial domain information, the fourth rule is a mapping of an order of the information of the groups.

In at least one embodiment, the order is at least one of a priority order, a report order or a priority level.

In at least one embodiment, for two or more of the CSI reports, the rule further includes that:
the second rule takes precedence over the fourth rule; or
the fourth rule takes precedence over the second rule; or
the second rule and the fourth rule are independent of each other.

In at least one embodiment, at least one of the CSI reports includes at least two types of CSI among the first CSI, the second CSI, the third CSI and the fourth CSI, the at least two types of CSI having the first rule.

In at least one embodiment, at least one of the first CSI, the second CSI or the third CSI includes a first part and a second part, the first part including at least a part of information of ranks of a spatial channel matrix and/or information of channel quality, and/or information of layers.

In at least one embodiment, the information of ranks of the spatial channel matrix is a rank indicator (RI).

In at least one embodiment, the information of channel quality is a channel quality indicator (CQI).

In at least one embodiment, the information of layers is a layer indicator (LI).

In at least one embodiment, rank indicators of the first CSI, the second CSI, the third CSI and the fourth CSI are the same, the terminal equipment reports one of the rank indicators; or,
rank indicators of at least two of the first CSI, the second CSI, the third CSI and the fourth CSI are different, the terminal equipment reports the at least two of the rank indicators or different rank indicators.

In at least one embodiment, at least a part of the second part is precoding matrix information.

In at least one embodiment, the number of the CSI reports is at least two, and the rule is associated with the second rule, the first rule, the third rule or the fourth rule; or
in one of the CSI reports, the rule is associated with the first rule and the third rule or the fourth rule.

In at least one embodiment, the number of the CSI reports is at least two, and the rule is that:
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.

In at least one embodiment, in one of the CSI reports, the rule is that:
the first rule takes precedence over the third rule or the fourth rule; or
the third rule or the fourth rule takes precedence over the first rule.

In at least one embodiment, the terminal equipment is configured with information of the rule by the network device, the information including an index and/or a number and/or a bitmap of the rule; and/or
the terminal equipment transmits information of the determined rule, the information including an index and/or a number and/or bitmap of the rule.

### Embodiments of a Fourth Aspect

Embodiments of a fourth aspect of the present disclosure provide an apparatus for receiving channel state information, applicable to a network device and corresponding to the method in the embodiments of the second aspect.

FIG. 6 is a schematic diagram of an apparatus for receiving channel state information in the embodiments of a fourth aspect. As shown in FIG. 6, an apparatus 600 includes a second processing unit 601.

In at least one embodiment, the second processing unit 601 controls the network device to perform the following operation:
the network device receives part or all of at least one channel state information (CSI) report transmitted by a terminal equipment according to a rule, the CSI report including at least one of first CSI, second CSI or third CSI.

In at least one embodiment, the CSI report further includes fourth CSI.

In at least one embodiment, the rule is configured by the network device; or
the rule is determined by the terminal equipment, and the terminal equipment transmits the determined rule to the network device; or
   the rule is predefined.

In at least one embodiment, the terminal equipment receives information for indicating available rules for the terminal equipment and configured by the network device, wherein the number of the available rules indicated by the information is one, the rule is the one available rule; or, the number of the available rules indicated by the information is at least two, the rule is determined by the terminal equipment from the at least two available rules.

In at least one embodiment, the CSI report is associated with at least one CSI-RS resource.

In at least one embodiment, precoding matrix information of the first CSI is generated by an artificial intelligence model; and/or
at least a part of the second CSI is second information, the second information being obtained by performing scalar quantization on one or more elements of a right singular vector of a spatial channel matrix and/or a eigenvector of the spatial channel matrix and/or of the spatial channel matrix; and/or
at least a part of the fourth CSI is precoding matrix information obtained by applying a first codebook to the right singular vector of the spatial channel matrix and/or the eigenvector of the spatial channel matrix; and/or
at least a part of the third CSI is third information, the third information being precoding matrix information obtained by applying a codebook obtained by expanding a value range of at least one parameter of the first codebook, to the right singular vector of the spatial channel matrix and/or the eigenvector of the spatial channel matrix.

In at least one embodiment, the rule includes at least one of a first rule, a second rule, a third rule or a fourth rule, wherein:
the first rule is an order corresponding to CSI types; and/or
the second rule is an order of the CSI reports; and/or
the third rule is an order of the second information in each CSI report; and/or
the fourth rule is an order of the third information in CSI report.

In at least one embodiment, the order is at least one of a priority order, a report order or a priority level.

In at least one embodiment, the first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook.

In at least one embodiment, in one piece of the second CSI of one of the CSI reports, the third rule is associated with frequency domain information and/or spatial domain information.

In at least one embodiment, the frequency domain information includes information of subbands and/or information of subcarriers and/or information of bandwidths;
the spatial domain information includes information of spatial domain layers and/or information of antenna ports.

In at least one embodiment, the information of subbands and/or information of subcarriers and/or information of bandwidths and/or the information of spatial domain layers and/or information of antenna ports include(s) at least one of an index, a bitmap or an identifier.

In at least one embodiment, for two or more of the CSI reports, the rule further includes that:
the second rule takes precedence over the third rule; or
the third rule takes precedence over the second rule; or
the second rule and the third rule are independent of each other.

In at least one embodiment, the third rule is a mapping of an order of the frequency domain information, wherein for the same frequency domain information, the third rule is a mapping of an order of the spatial domain information; or
the third rule is a mapping of an order of the spatial domain information, wherein for the same spatial domain information, the third rule is a mapping of an order of the frequency domain information.

In at least one embodiment, the order is at least one of a priority order, a report order or a priority level.

In at least one embodiment, in the same third CSI of the same CSI report, the fourth rule of the third CSI is associated with spatial domain information.

In at least one embodiment, the third information includes two or more groups, at least one of the groups including spatial domain layer information, and the fourth rule includes:
obtaining an order of the two or more groups according to the spatial domain information and/or information of the groups.

In at least one embodiment, the information of the groups includes at least one of an index, a bitmap, a number or an identifier.

In at least one embodiment, the fourth rule is a mapping of an order of the information of the groups, wherein for the same information of the groups, the fourth rule is a mapping of an order of the spatial domain information; or the fourth rule is a mapping of an order of the spatial domain information, wherein for the same spatial domain information, the fourth rule is a mapping of an order of the information of the groups.

In at least one embodiment, the order is at least one of a priority order, a report order or a priority level.

In at least one embodiment, for two or more of the CSI reports, the rule further includes that:
the second rule takes precedence over the fourth rule; or
the fourth rule takes precedence over the second rule; or
the second rule and the fourth rule are independent of each other.

In at least one embodiment, at least one of the CSI reports includes at least two types of CSI among the first CSI, the second CSI, the third CSI and the fourth CSI, the at least two types of CSI having the first rule.

In at least one embodiment, at least one of the first CSI, the second CSI or the third CSI includes a first part and a second part, the first part including at least a part of information of ranks of a spatial channel matrix and/or information of channel quality, and/or information of layers.

In at least one embodiment, the information of ranks of the spatial channel matrix is a rank indicator (RI).

In at least one embodiment, the information of channel quality is a channel quality indicator (CQI).

In at least one embodiment, the information of layers is a layer indicator (LI).

In at least one embodiment, rank indicators of the first CSI, the second CSI, the third CSI or the fourth CSI are the same, the network device receives one of the rank indicators reported by the terminal equipment; or,
rank indicators of at least two of the first CSI, the second CSI, the third CSI and the fourth CSI are different, the network device receives the at least two of the rank indicators or different rank indicators reported by the terminal equipment.

In at least one embodiment, at least a part of the second part is precoding matrix information.

In at least one embodiment, the number of the CSI reports is at least two, and the rule is associated with the second rule, the first rule, the third rule or the fourth rule; or
in one of the CSI reports, the rule is associated with the first rule and the third rule or the fourth rule.

In at least one embodiment, the number of the CSI reports is at least two, and the rule is that:
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.

In at least one embodiment, in one of the CSI reports, the rule is that the first rule takes precedence over the third rule or the fourth rule; or
the third rule or the fourth rule takes precedence over the first rule.

In at least one embodiment, the network device configures information of the rule, the information including an index and/or a number and/or bitmap of the rule; and/or
the network device receives information of the determined rule from the terminal equipment, the information including an index and/or a number and/or a bitmap of the rule.

### Embodiments of a Fifth Aspect

Embodiments of a fifth aspect of the present disclosure provide a communication system, the communication system may include a network device and a terminal equipment.

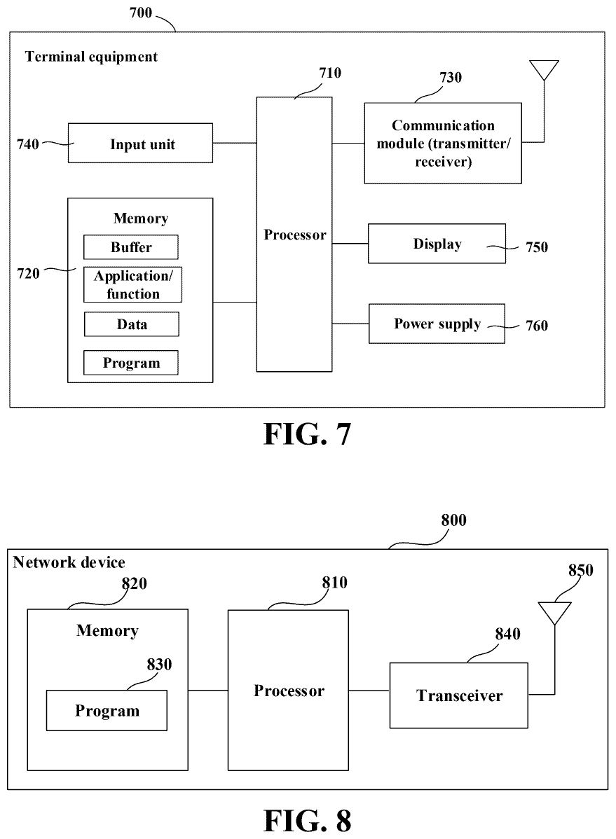

FIG. 7 is a schematic diagram of a terminal equipment in the embodiments of a fifth aspect. As shown in FIG. 7, a terminal equipment 700 (for example, corresponding to the terminal equipment 202 in FIG. 2) may include a processor 710 and a memory 720; the memory 720 stores data and programs, and is coupled to the processor 710. It's worth noting that this figure is exemplary; other types of structures can also be used to supplement or replace this structure, so as to realize a telecommunication function or other functions.

For example, the processor 710 may be configured to execute a program to implement the method in the embodiments of the first aspect.

As shown in FIG. 7, the terminal equipment 700 may further include: a communication module 730, an input unit 740, a display 750 and a power supply 760. The functions of the components are similar to prior arts, which are not repeated here. It's worth noting that the terminal equipment 700 does not have to include all the components shown in FIG. 7, the components are not indispensable. Moreover, the terminal equipment 700 may further include components not shown in FIG. 7, prior arts may be referred to.

FIG. 8 is a schematic diagram of a network device in the embodiments of a fifth aspect. As shown in FIG. 8, a network device 800 (for example, corresponding to the network device 201 in FIG. 2) may include: a processor 810 (such as a central processing unit (CPU)) and a memory 820; the memory 820 is coupled to the processor 810. The memory 820 may store various data; moreover, further stores a program 830 for information processing, and executes the program 830 under the control of the processor 810.

For example, the processor 810 may be configured to execute a program to implement the method as described in the embodiments of the second aspect.

In addition, as shown in FIG. 8, the network device 800 may further include: a transceiver 840 and an antenna 850, etc., wherein the functions of the components are similar to prior arts, which are not repeated here. It's worth noting that the network device 800 does not have to include all the components shown in FIG. 8. Moreover, the network device 800 may further include components not shown in FIG. 8, prior arts may be referred to.

Embodiments of the present disclosure further provide a computer program, wherein when a terminal equipment executes the program, the program enables the terminal equipment to execute the method described in the embodiments of the first aspect.

Embodiments of the present disclosure further provide a storage medium in which a computer program is stored, wherein the computer program enables a terminal equipment to execute the method described in the embodiments of the first aspect.

Embodiments of the present disclosure further provide a computer program, wherein when a network device executes the program, the program enables the network device to execute the method described in the embodiments of the second aspect.

Embodiments of the present disclosure further provide a storage medium in which a computer program is stored, wherein the computer program enables a network device to execute the method described in the embodiments of the second aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, and a flash memory.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipments, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:

### Method at a Terminal Side:

1. A method for transmitting channel state information, applicable to a terminal equipment, the method including:
the terminal equipment generates at least one channel state information (CSI) report, the CSI report including at least one of first CSI, second CSI or third CSI; and
the terminal equipment transmits part or all of at least one of the CSI report to a network device according to a rule.
2. The method according to supplement 1, wherein, the CSI report further includes fourth CSI.
3. The method according to supplement 1, wherein, the rule is configured by the network device; or
the rule is determined by the terminal equipment, and the terminal equipment transmits the rule that is determined to the network device; or
the rule is predefined.
4. The method according to supplement 3, wherein,
the terminal equipment receives information for indicating an available rule for the terminal equipment, configured by the network device,
wherein the number of the available rules indicated by the information is one, the rule is the one available rule; or,
the number of the available rules indicated by the information is more than two, the rule is determined by the terminal equipment from the at least two available rules.
5. The method according to supplement 2, wherein,
the CSI report is associated with at least one CSI-RS resource.
6. The method according to supplement 2, wherein,
precoding matrix information of the first CSI is generated by an artificial intelligence model; and/or
at least a part of the second CSI is second information, the second information being obtained by performing scalar quantization on one or more elements of a right singular vector of a spatial channel matrix and/or of a eigenvector of the spatial channel matrix and/or of the spatial channel matrix; and/or
at least a part of the fourth CSI is precoding matrix information obtained by applying a first codebook to the right singular vector of the spatial channel matrix and/or the eigenvector of the spatial channel matrix; and/or
at least a part of the third CSI is third information, the third information being precoding matrix information obtained by applying a codebook obtained by expanding a value range of at least one parameter of the first codebook, to the right singular vector of the spatial channel matrix and/or the eigenvector of the spatial channel matrix.
7. The method according to supplement 6, wherein,
the rule includes at least one of a first rule, a second rule, a third rule or a fourth rule,
the first rule is an order corresponding to CSI types; and/or
the second rule is an order of the CSI reports; and/or
the third rule is an order of the second information in each CSI report; and/or
the fourth rule is an order of the third information in each CSI report.
8. The method according to supplement 7, wherein,
the order is at least one of a priority order, a report order or a priority level.
9. The method according to supplement 6, wherein,
the first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook.
10. The method according to supplement 7, wherein,
in one piece of the second CSI of one of the CSI reports, the third rule is associated with frequency domain information and/or spatial domain information.
11. The method according to supplement 10, wherein,
the frequency domain information includes information of subbands and/or information of subcarriers and/or information of bandwidths;
the spatial domain information includes information of spatial domain layers and/or information of antenna ports.
12. The method according to supplement 11, wherein,
the information of subbands and/or information of subcarriers and/or information of bandwidths and/or the information of spatial domain layers and/or information of antenna ports include(s) at least one of an index, a bitmap or an identifier.
13. The method according to supplement 7, wherein,
for two or more of the CSI reports, the rule further includes that:
the second rule takes precedence over the third rule; or
the third rule takes precedence over the second rule; or
the second rule and the third rule are independent of each other.
14. The method according to supplement 7, wherein,
the third rule is a mapping of an order of the frequency domain information, wherein for the same frequency domain information, the third rule is a mapping of an order of the spatial domain information; or
the third rule is a mapping of an order of the spatial domain information, wherein for the same spatial domain information, the third rule is a mapping of an order of the frequency domain information.
15. The method according to supplement 14, wherein,
the order is at least one of a priority order, a report order or a priority level.
16. The method according to supplement 7, wherein,
in the third CSI of one CSI report, the fourth rule of the third CSI is associated with spatial domain information.
17. The method according to supplement 16, wherein,
the third information includes two or more groups, at least one of the groups including spatial domain layer information, and
the fourth rule includes:
obtaining an order of the two or more groups according to the spatial domain information and/or information of the groups.
18. The method according to supplement 17, wherein,
the information of the groups includes at least one of an index, a bitmap, a number or an identifier.
19. The method according to supplement 17, wherein,
the fourth rule is a mapping of an order of the information of the groups, wherein for the same information of the groups, the fourth rule is a mapping of an order of the spatial domain information; or
the fourth rule is a mapping of an order of the spatial domain information, wherein for the same spatial domain information, the fourth rule is a mapping of an order of the information of the groups.
20. The method according to supplement 19, wherein,
the order is at least one of a priority order, a report order or a priority level.
21. The method according to supplement 16, wherein,
for two or more of the CSI reports, the rule further includes that:
the second rule takes precedence over the fourth rule; or
the fourth rule takes precedence over the second rule; or
the second rule and the fourth rule are independent of each other.
22. The method according to supplement 7, wherein,
at least one of the CSI reports includes at least two types of CSI among the first CSI, the second CSI, the third CSI and the fourth CSI, the at least two types of CSI having the first rule.
23. The method according to supplement 22, wherein,
at least one of the first CSI, the second CSI or the third CSI includes a first part and a second part, the first part including at least a part of information of ranks of a spatial channel matrix and/or information of channel quality, and/or information of layers.
24. The method according to supplement 23, wherein,
the information of ranks of the spatial channel matrix is a rank indicator (RI).
25. The method according to supplement 23, wherein,
the information of channel quality is a channel quality indicator (CQI).
26. The method according to supplement 23, wherein,
the information of layers is a layer indicator (LI).
27. The method according to supplement 22, wherein,
rank indicators of the first CSI, the second CSI, the third CSI and the fourth CSI are the same, the terminal equipment reports one of the rank indicators; or,
rank indicators of at least two of the first CSI, the second CSI, the third CSI and the fourth CSI are different, the terminal equipment reports the at least two of the rank indicators or different rank indicators.
28. The method according to supplement 23, wherein,
at least a part of the second part is precoding matrix information.
29. The method according to supplement 28, wherein,
the number of the CSI reports is at least two, and the rule is related to the second rule, the first rule, the third rule or the fourth rule; or
in one of the CSI reports, the rule is related to the first rule and the third rule or the fourth rule.
30. The method according to supplement 29, wherein,
the number of the CSI reports is at least two, and the rule is that
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.
31. The method according to supplement 29, wherein,
in one of the CSI reports, the rule is that
the first rule takes precedence over the third rule or the fourth rule; or
the third rule or the fourth rule takes precedence over the first rule.
32. The method according to supplement 3, wherein,
the terminal equipment is configured with information of the rule by the network device, the information including an index and/or a number and/or a bitmap of the rule; and/or
the terminal equipment transmits information of the rule determined, the information including an index and/or a number and/or a bitmap of the rule.

### Method at a Network Side:

1. A method for receiving channel state information, applicable to a network device, the method including:
the network device receives part or all of at least one channel state information (CSI) report transmitted by a terminal equipment according to a rule, the CSI report including at least one of first CSI, second CSI or third CSI.
2. The method according to supplement 1, wherein,
the CSI report further includes fourth CSI.
3. The method according to supplement 1, wherein,
the rule is configured by the network device; or
the network device receives the rule that is determined by the terminal equipment; or
the rule is predefined.
4. The method according to supplement 3, wherein,
the network device configures, for the terminal equipment, information for indicating an available rule for the terminal equipment,
wherein the number of the available rules indicated by the information is one, the rule is the one available rule; or,
the number of the available rules indicated by the information is more than two, the rule is determined by the terminal equipment from the at least two available rules.
5. The method according to supplement 2, wherein,
the CSI report is associated with at least one CSI-RS resource.
6. The method according to supplement 2, wherein,
precoding matrix information of the first CSI is generated by an artificial intelligence model; and/or
at least a part of the second CSI is second information, the second information being obtained by performing scalar quantization on one or more elements of a right singular vector of a spatial channel matrix and/or of a eigenvector of the spatial channel matrix and/or of the spatial channel matrix; and/or
at least a part of the fourth CSI is precoding matrix information obtained by applying a first codebook to the right singular vector of the spatial channel matrix and/or the eigenvector of the spatial channel matrix; and/or
at least a part of the third CSI is third information, the third information being precoding matrix information obtained by applying a codebook obtained by expanding a value range of at least one parameter of the first codebook, to the right singular vector of the spatial channel matrix and/or the eigenvector of the spatial channel matrix.
7. The method according to supplement 6, wherein,
the rule includes at least one of a first rule, a second rule, a third rule or a fourth rule,
the first rule is an order corresponding to CSI types; and/or
the second rule is an order of the CSI reports; and/or
the third rule is an order of the second information in each CSI report; and/or
the fourth rule is an order of the third information in each CSI report.
8. The method according to supplement 7, wherein,
the order is at least one of a priority order, a report order or a priority level.
9. The method according to supplement 6, wherein,
the first codebook is at least one of a Type I single-panel codebook, a Type I multi-panel codebook, a Type II codebook, a Type II port selection codebook, an enhanced Type II codebook, an enhanced Type II port selection codebook or a further enhanced Type II port selection codebook.
10. The method according to supplement 7, wherein,
in one piece of the second CSI of one of the CSI reports, the third rule is associated with frequency domain information and/or spatial domain information.
11. The method according to supplement 10, wherein,
the frequency domain information includes information of subbands and/or information of subcarriers and/or information of bandwidths;
the spatial domain information includes information of spatial domain layers and/or information of antenna ports.
12. The method according to supplement 11, wherein,
the information of subbands and/or information of subcarriers and/or information of bandwidths and/or the information of spatial domain layers and/or information of antenna ports include(s) at least one of an index, a bitmap or an identifier.
13. The method according to supplement 7, wherein,
for two or more of the CSI reports, the rule further includes that:
the second rule takes precedence over the third rule; or
the third rule takes precedence over the second rule; or
the second rule and the third rule are independent of each other.
14. The method according to supplement 7, wherein,
the third rule is a mapping of an order of the frequency domain information, wherein for the same frequency domain information, the third rule is a mapping of an order of the spatial domain information; or
the third rule is a mapping of an order of the spatial domain information, wherein for the same spatial domain information, the third rule is a mapping of an order of the frequency domain information.
15. The method according to supplement 14, wherein,
the order is at least one of a priority order, a report order or a priority level.
16. The method according to supplement 7, wherein,
in the same third CSI of the same CSI report, the fourth rule of the third CSI is associated with spatial domain information.
17. The method according to supplement 16, wherein,
the third information includes two or more groups, at least one of the groups including spatial domain layer information, and
the fourth rule includes:
obtaining an order of the two or more groups according to the spatial domain information and/or information of the groups.
18. The method according to supplement 17, wherein,
the information of the groups includes at least one of an index, a bitmap, a number or an identifier.
19. The method according to supplement 18, wherein,
the fourth rule is a mapping of an order of the information of the groups, wherein for the same information of the groups, the fourth rule is a mapping of an order of the spatial domain information; or
the fourth rule is a mapping of an order of the spatial domain information, wherein for the same spatial domain information, the fourth rule is a mapping of an order of the information of the groups.
20. The method according to supplement 19, wherein,
the order is at least one of a priority order, a report order or a priority level.
21. The method according to supplement 16, wherein,
for two or more of the CSI reports, the rule further includes that:
the second rule takes precedence over the fourth rule; or
the fourth rule takes precedence over the second rule; or
the second rule and the fourth rule are independent of each other.
22. The method according to supplement 7, wherein,
at least one of the CSI reports includes at least two types of CSI among the first CSI, the second CSI, the third CSI and the fourth CSI, the at least two types of CSI having the first rule.
23. The method according to supplement 22, wherein,
at least one of the first CSI, the second CSI or the third CSI includes a first art and a second part, the first part including at least a part of information of ranks of a spatial channel matrix and/or information of channel quality, and/or information of layers.
24. The method according to supplement 23, wherein,
the information of ranks of the spatial channel matrix is a rank indicator (RI).
25. The method according to supplement 23, wherein,
the information of channel quality is a channel quality indicator (CQI).
26. The method according to supplement 23, wherein,
the information of layer is a layer indicator (LI).
27. The method according to supplement 22, wherein,
rank indicators of the first CSI, the second CSI, the third CSI and the fourth CSI are the same, the network device receives one of the rank indicators reported by the terminal equipment; or,
rank indicators of at least two of the first CSI, the second CSI, the third CSI or the fourth CSI are different, the network device receives the at least two of the rank indicators or different rank indicators reported by the terminal equipment.
28. The method according to supplement 23, wherein,
at least a part of the second part is precoding matrix information.
29. The method according to supplement 28, wherein,
the number of the CSI reports is at least two, and the rule is associated with the second rule, the first rule, the third rule or the fourth rule; or
in one of the CSI reports, the rule is associated with the first rule and the third rule or the fourth rule.
30. The method according to supplement 29, wherein,
the number of the CSI reports is at least two, and the rule is that:
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.
31. The method according to supplement 29, wherein,
in one of the CSI reports, the rule is that:
the first rule takes precedence over the third rule or the fourth rule; or
the third rule or the fourth rule takes precedence over the first rule.
32. The method according to supplement 3, wherein,
the network device configures information of the rule, the information including an index and/or a number and/or bitmap of the rule; and/or
the network device receives information of the determined rule from the terminal equipment, the information including an index and/or a number and/or a bitmap of the rule.

What is claimed is:

1. An apparatus for transmitting channel state information, applicable to a terminal equipment, the apparatus comprising:
first processor circuitry controlling the terminal equipment to perform the following operations:
generating one or more channel state information (CSI) report(s), the CSI report comprising at least one of first CSI, second CSI or third CSI; and
transmitting part or all of at least one of the CSI report to a network device according to a rule.

2. The apparatus according to claim 1, wherein,
the CSI report further comprises fourth CSI.

3. The apparatus according to claim 1, wherein,
the rule is configured by the network device; or
the rule is determined by the terminal equipment, and the terminal equipment transmits the rule that is determined to the network device; or
the rule is predefined.

4. The apparatus according to claim 2, wherein,
the CSI report is associated with at least one CSI-RS resource.

5. The apparatus according to claim 2, wherein,
precoding matrix information of the first CSI is generated by an artificial intelligence model; and/or
at least a part of the second CSI is second information, the second information being obtained by performing scalar quantization on one or more elements of a right singular vector of a spatial channel matrix, and/or of an eigenvector of a spatial channel matrix and/or of a spatial channel matrix; and/or
at least a part of the fourth CSI is precoding matrix information obtained by applying a first codebook to a right singular vector of a spatial channel matrix and/or an eigenvector of a spatial channel matrix; and/or
at least a part of the third CSI is third information, the third information being precoding matrix information obtained by applying a codebook obtained by expanding a value range of at least one parameter of a first codebook, to a right singular vector of a spatial channel matrix and/or an eigenvector of a spatial channel matrix.

6. The apparatus according to claim 5, wherein,
the rule comprises at least one of a first rule, a second rule, a third rule or a fourth rule,
the first rule is an order corresponding to CSI types; and/or
the second rule is an order of the CSI reports; and/or
the third rule is an order of the second information in each CSI report; and/or
the fourth rule is an order of the third information in each CSI report.

7. The apparatus according to claim 6, wherein,
in one piece of the second CSI of one of the CSI reports, the third rule is associated with frequency domain information and/or spatial domain information.

8. The apparatus according to claim 6, wherein,
for two or more of the CSI reports, the rule further comprises that:
the second rule takes precedence over the third rule; or
the third rule takes precedence over the second rule; or
the second rule and the third rule are independent of each other.

9. The apparatus according to claim 6, wherein,
in the third CSI of one CSI report, the fourth rule of the third CSI is associated with spatial domain information.

10. The apparatus according to claim 9, wherein,
the third information comprises two or more groups, at least one of the groups comprising spatial domain layer information, and
the fourth rule comprises:
obtaining an order of the two or more groups according to the spatial domain information and/or information of the groups.

11. The apparatus according to claim 10, wherein,
the fourth rule is a mapping of an order of the information of the groups, wherein for the same information of the groups, the fourth rule is a mapping of an order of the spatial domain information; or
the fourth rule is a mapping of an order of the spatial domain information, wherein for the same spatial domain information, the fourth rule is a mapping of an order of the information of the groups.

12. The apparatus according to claim 9, wherein,
for two or more of the CSI reports, the rule further comprises that:
the second rule takes precedence over the fourth rule; or
the fourth rule takes precedence over the second rule; or
the second rule and the fourth rule are independent of each other.

13. The apparatus according to claim 6, wherein,
at least one of the CSI reports comprises at least two of the first CSI, the second CSI, the third CSI and the fourth CSI,
the at least two types of CSI having the first rule.

14. The apparatus according to claim 13, wherein,
at least one of the first CSI, the second CSI or the third CSI comprises a first part and a second part, the first part comprising information of ranks of a spatial channel matrix and/or at least a part of information of channel quality and/or information of a layer.

15. The apparatus according to claim 14, wherein,
at least a part of the second part is precoding matrix information.

16. The apparatus according to claim 15, wherein,
the number of the CSI reports is at least two, and the rule is related to the second rule, the first rule, and either the third rule or the fourth rule; or
in one of the CSI reports, the rule is related to the first rule and the third rule or the fourth rule.

17. The apparatus according to claim 16, wherein,
the number of the CSI reports is at least two, and the rule is that:
the second rule takes precedence over the first rule, and the first rule takes precedence over the third rule or the fourth rule; or
the second rule takes precedence over the third rule or the fourth rule, and the third rule or the fourth rule takes precedence over the first rule; or
the first rule takes precedence over the second rule, and the second rule takes precedence over the third rule or the fourth rule; or
the first rule takes precedence over the third rule or the fourth rule, and the third rule or the fourth rule takes precedence over the second rule; or
the third rule or the fourth rule takes precedence over the first rule, and the first rule takes precedence over the second rule; or
the third rule or the fourth rule takes precedence over the second rule, and the second rule takes precedence over the first rule.

18. The apparatus according to claim 16, wherein,
in one of the CSI reports, the rule is that:
the first rule takes precedence over the third rule or the fourth rule; or
the third rule or the fourth rule takes precedence over the first rule.

19. The apparatus according to claim 3, wherein,
the terminal equipment is configured with information of the rule by the network device, the information comprising an index and/or a number and/or a bitmap of the rule; and/or
the terminal equipment transmits information of the rule that is determined, the information comprising an index and/or a number and/or a bitmap of the rule.

20. An apparatus for receiving channel state information, applicable to a network device, the apparatus comprising:
second processor circuitry controlling the network device to perform the following operation:
receiving part or all of at least one channel state information (CSI) report transmitted by a terminal equipment according to a rule, the CSI report comprising at least one of first CSI, second CSI or third CSI.
